(19) United States
(12) Patent Application Publication
(10) Pub. No.: US 2025/0278481 A2
(43) Pub. Date: Sep. 4, 2025

(54) ROW HAMMER MITIGATION FOR STACKED MEMORY ARCHITECTURES

(71) Applicant: Micron Technology, Inc., Boise, ID (US)

(72) Inventors: Nathan A. Eckel, Lufkin, TX (US); Chun-Yi Liu, Rancho Cordova, CA (US); Lance P. Johnson, Saint Paul, MN (US); James Brian Johnson, Boise, ID (US); Yang Lu, Boise, ID (US)

(21) Appl. No.: 18/763,963

(22) Filed: Jul. 3, 2024

Related U.S. Application Data
(60) Provisional application No. 63/517,849, filed on Aug. 4, 2023.

(51) Int. Cl. G06F 21/55

(52) U.S. Cl. CPC G06F 21/554; G06F 2221/034

(57) ABSTRACT

Methods, systems, and devices for row hammer mitigation for stacked memory architectures are described. A semiconductor system, such as a memory system, may distribute operations for row hammer mitigation across circuitry of the semiconductor system. A first interface block of a first die of the semiconductor system may exchange signaling with a second interface block of a second die of the semiconductor system to perform row hammer mitigation operations. The second die may implement counters to track quantities of access operations associated with respective rows of memory cells of the second die. The second interface block may transmit alert signaling to the first interface block based on a value of a counter, and the first interface block may evaluate the alert signaling and transmit refresh signaling to the second interface block to perform one or more refresh operations.

### CROSS REFERENCE

The present application for patent claims priority to U.S. Patent Application No. 63/517,849 by Eckel et al., entitled “ROW HAMMER MITIGATION FOR STACKED MEMORY ARCHITECTURES,” filed Aug. 4, 2023, which is assigned to the assignee hereof, and which is expressly incorporated by reference in its entirety herein.

### TECHNICAL FIELD

The following relates to one or more systems for memory, including row hammer mitigation for stacked memory architectures.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells in a non-volatile configuration may maintain stored logic states for extended periods of time even in the absence of an external power source. Memory cells in a volatile configuration may lose stored states when disconnected from an external power source.

### BRIEF DESCRIPTION OF THE DRAWINGS

FIG. 1 shows an example of a system that supports row hammer mitigation for stacked memory architectures in accordance with examples as disclosed herein.

FIG. 2 shows an example of a system that supports row hammer mitigation for stacked memory architectures in accordance with examples as disclosed herein.

FIG. 3 shows an example of an interface architecture that supports row hammer mitigation for stacked memory architectures in accordance with examples as disclosed herein.

FIG. 4 shows an example of a system that supports row hammer mitigation for stacked memory architectures in accordance with examples as disclosed herein.

FIG. 5 shows an example of an architecture that supports row hammer mitigation for stacked memory architectures in accordance with examples as disclosed herein.

FIG. 6 shows a block diagram of a logic die that supports row hammer mitigation for stacked memory architectures in accordance with examples as disclosed herein.

FIG. 7 shows a block diagram of an array die that supports row hammer mitigation for stacked memory architectures in accordance with examples as disclosed herein.

FIGS. 8 and 9 show flowcharts illustrating methods that support row hammer mitigation for stacked memory architectures in accordance with examples as disclosed herein.

### DETAILED DESCRIPTION

Some memory systems may include a stack of semiconductor dies, including one or more memory dies above a logic die that is operable to access a set of memory arrays distributed across the one or more memory dies. Such an architecture may be implemented as part of a coupled dynamic random access memory (DRAM) system, and may support solutions for memory-centric logic, such as graphics processing units (GPUs), among other implementations. In some examples, a 3D stacked memory system may be closely coupled (e.g., physically coupled, electrically coupled) with a processor, such as a GPU or other host, as part of a physical memory map accessible to the processor. Such coupling may include one or more processors being implemented in a same semiconductor die as at least a portion of a 3D stacked memory system (e.g., as part of a logic die), or a processor being implemented in a die that is directly coupled (e.g., fused) with another die that includes at least a portion of a 3D stacked memory system. Unlike cache-based memory, a 3D stacked memory system may not be backed by a level of external memory with the same physical addresses. For example, a 3D stacked memory system may be associated with and located within a dedicated base address, where each portion of the 3D stacked memory system may be non-overlapping within the address.

In some memory systems that implement a stack of semiconductor dies, memory access circuitry may be distributed among (e.g., across, between) multiple semiconductor dies. For instance, multiple semiconductor dies of a 3D stacked memory system may include a stack of semiconductor dies (e.g., a stack of multiple directly-coupled semiconductor die), including a first die (e.g., a logic die) that is operable to access a set of memory arrays distributed across one or more second dies (e.g., array dies). The logic die may access the set of memory arrays via a first interface block (e.g., memory interface block (MIB)) included in the logic die. The first interface block may communicate with one or more second interface blocks of one or more array dies to access one or more memory arrays. In some cases, a memory array may be organized with multiple rows, and the rows may be physically located near (e.g., adjacent to) each other in the memory array. Each row may include a set of memory cells and may be accessed via a respective address (e.g., a physical address). In some cases, a row (e.g., and its associated memory cells) may be subject to adverse accessing, such as row hammer attacks. Row hammer attacks may include repeated access operations to one or more first rows (e.g., an aggressor row), which may adversely affect one or more neighboring rows (e.g., victim rows, adjacent rows). For example, repeatedly accessing a row may disturb memory cells of one or more neighboring rows such that data stored by the memory cells may be modified (e.g., compromised, corrupted).

In accordance with examples as disclosed herein, a semiconductor system, such as a 3D stacked memory system or other memory system, may distribute functionality for row hammer mitigation among multiple dies of the semiconductor system. In some examples, a first interface block (e.g., a memory interface block (MIB)) of a first die (e.g., a logic die) of the semiconductor system and a second interface block of a second die (e.g., an array die) of the semiconductor system may exchange signaling (e.g., one or more signals, one or more indications) to coordinate and perform row hammer mitigation operations. For example, a first interface block may transmit access signaling to the second interface block to access a row of a memory array of the second die. The second die may include counters (e.g., at or associated with a memory array of the array die) that are each associated with a respective row of the memory array (e.g., as per-row counters). For example, each counter may be operable to track (e.g., count, monitor) a quantity of access operations (e.g., activations) associated with the respective row.

If a value of a counter satisfies one or more threshold values, the second interface block may transmit alert signaling to the first interface block. Such alert signaling may be indicative of a row hammer attack on a row (e.g., aggressor row) associated with the counter. To mitigate adverse effects of the row hammer attack, the first interface block may evaluate the alert signaling and may transmit refresh signaling to the second interface block. The refresh signaling may include one or more refresh commands for one or more neighboring rows (e.g., varying quantities of rows, victim rows) that are located near (e.g., adjacent to) the row. By distributing the operations for row hammer mitigation across multiple semiconductor dies in accordance with one or more of the described techniques, a system may be configured with more robust row hammer mitigation procedures, increased system security, and increased reliability, among other benefits, compared with other techniques for row hammer mitigation in a memory system.

Features of the disclosure are illustrated and described in the context of systems and dies (e.g., logic die, array dies). Features of the disclosure are further illustrated and described in the context of architectures, block diagrams, and flowcharts.

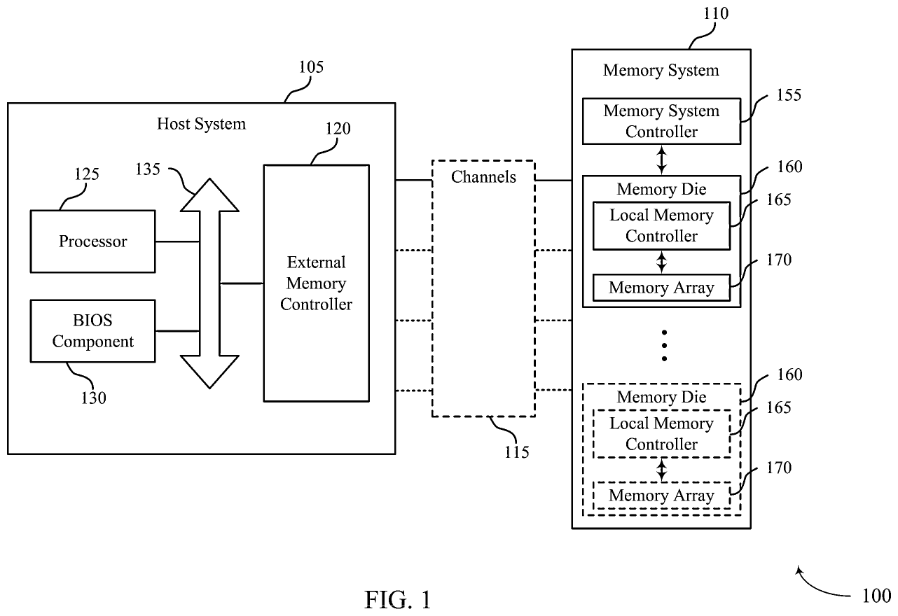

FIG. 1 illustrates an example of a system 100 that supports row hammer mitigation for stacked memory architectures in accordance with examples as disclosed herein. The system 100 may include portions of an electronic device, such as a computing device, a mobile computing device, a wireless communications device, a graphics processing device, a vehicle, or other systems. The system 100 includes a host system 105, a memory system 110, and one or more channels 115 coupling the host system 105 with the memory system 110 (e.g., to provide a communicative coupling). The system 100 may include one or more memory systems 110, but aspects of the one or more memory systems 110 may be described in the context of a single memory system 110.

The host system 105 may be an example of a processor (e.g., circuitry, processing circuitry, one or more processing components) that uses memory to execute processes, such as a processing system of a computing device, a mobile computing device, a wireless communications device, a graphics processing device, a wearable device, an internet-connected device, a vehicle controller, a system on a chip (SoC), or other stationary or portable electronic device, among other examples. The host system 105 may include one or more of an external memory controller 120, a processor 125, a basic input/output system (BIOS) component 130, or other components (e.g., a peripheral component, an input/output controller, not shown). The components of the host system 105 may be coupled with one another using a bus 135.

An external memory controller 120 may be configured to enable communication of information (e.g., data, commands, control information, configuration information) between components of the system 100 (e.g., between components of the host system 105, such as the processor 125, and the memory system 110). An external memory controller 120 may process (e.g., convert, translate) communications exchanged between the host system 105 and the memory system 110. In some examples, an external memory controller 120, or other component of the system 100, or associated functions described herein, may be implemented by or be part of the processor 125. For example, an external memory controller 120 may be hardware, firmware, or software (e.g., instructions), or some combination thereof implemented by a processor 125 or other component of the system 100 or the host system 105. Although an external memory controller 120 is illustrated outside the memory system 110, in some examples, an external memory controller 120, or its functions described herein, may be implemented by one or more components of a memory system 110 (e.g., a memory system controller 155, a local memory controller 165) or vice versa. In various examples, the host system 105 or an external memory controller 120 may be referred to as a host.

A processor 125 may be operable to provide functionality (e.g., control functionality) for the system 100 or the host system 105. A processor 125 may be a general-purpose processor, a digital signal processor (DSP), an application-specific integrated circuit (ASIC), a field-programmable gate array (FPGA) or other programmable logic device, discrete gate or transistor logic, discrete hardware components, or any combination thereof. In some examples, a processor 125 may be an example of a central processing unit (CPU), a graphics processing unit (GPU), a general-purpose GPU (GPGPU), or an SoC, among other examples.

In some examples, the system 100 or the host system 105 may include an input component, an output component, or a combination thereof. Input components may include a sensor, a microphone, a keyboard, another processor (e.g., on a printed circuit board), an interface (e.g., a user interface, an interface between other devices), or a peripheral that interfaces with system 100 via one or more peripheral components, among other examples. Output components may include a display, audio speakers, a printing device, another processor on a printed circuit board, or a peripheral that interfaces with the system 100 via one or more peripheral components, among other examples.

The memory system 110 may be a component of the system 100 that is operable to provide physical memory locations (e.g., addresses) that may be used or referenced by the system 100. The memory system 110 may include a memory system controller 155 and one or more memory dies 160 (e.g., memory chips) to support a capacity for data storage. The memory system 110 may be configurable to work with one or more different types of host systems 105, and may respond to and execute commands provided by the host system 105 (e.g., via an external memory controller 120). For example, the memory system 110 (e.g., a memory system controller 155) may receive a write command indicating that the memory system 110 is to store data received from the host system 105, or receive a read command indicating that the memory system 110 is to provide data stored in a memory die 160 to the host system 105, or receive a refresh command indicating that the memory system 110 is to refresh data stored in a memory die 160, among other types of commands and operations.

A memory system controller 155 may include components (e.g., circuitry, logic) operable to control operations of the memory system 110. A memory system controller 155 may include hardware, firmware, or instructions that enable the memory system 110 to perform various operations, and may be operable to receive, transmit, or execute commands, data, or control information related to operations of the memory system 110. A memory system controller 155 may be operable to communicate with one or more of an external memory controller 120, one or more memory dies 160, or a processor 125. In some examples, a memory system controller 155 may control operations of the memory system 110 in cooperation with a local memory controller 165 of a memory die 160.

Each memory die 160 may include a local memory controller 165 and a memory array 170. A memory array 170 may be a collection of memory cells, with each memory cell being operable to store one or more bits of data. A memory die 160 may include a two-dimensional (2D) array of memory cells, or a three-dimensional (3D) array of memory cells. In some examples, a 2D memory die 160 may include a single memory array 170. In some examples, a 3D memory die 160 may include two or more memory arrays 170, which may be stacked or positioned beside one another (e.g., relative to a substrate).

A local memory controller 165 may include components (e.g., circuitry, logic) operable to control operations of a memory die 160. In some examples, a local memory controller 165 may be operable to communicate (e.g., receive or transmit data or commands or both) with a memory system controller 155. In some examples, a memory system 110 may not include a memory system controller 155, and a local memory controller 165 or an external memory controller 120 may perform various functions described herein. As such, a local memory controller 165 may be operable to communicate with a memory system controller 155, with other local memory controllers 165, or directly with an external memory controller 120, or a processor 125, or any combination thereof. Examples of components that may be included in a memory system controller 155 or a local memory controller 165 or both may include receivers for receiving signals (e.g., from the external memory controller 120), transmitters for transmitting signals (e.g., to the external memory controller 120), decoders for decoding or demodulating received signals, encoders for encoding or modulating signals to be transmitted, sense components for sensing states of memory cells of a memory array 170, write components for writing states to memory cells of a memory array 170, or various other components operable for supporting described operations of a memory system 110.

A host system 105 (e.g., an external memory controller 120) and a memory system 110 (e.g., a memory system controller 155) may communicate information (e.g., data, commands, control information, configuration information) using one or more channels 115. Each channel 115 may be an example of a transmission medium that carries information, and each channel 115 may include one or more signal paths (e.g., a transmission medium, an electrical conductor, an electrically conductive path) between terminals associated with the components of the system 100. For example, a channel 115 may be associated with a first terminal (e.g., including one or more pins, including one or more pads) at the host system 105 and a second terminal at the memory system 110. A terminal may be an example of a conductive input or output point of a device of the system 100, and a terminal may be operable to act as part of a channel 115. In some implementations, at least the channels 115 between a host system 105 and a memory system 110 may include or be referred to as a host interface (e.g., a physical host interface). In some implementations, a host interface may include or be associated with interface circuitry (e.g., signal drivers, signal latches) at the host system 105 (e.g., at an external memory controller 120), or at the memory system 110 (e.g., at a memory system controller 155), or both.

In some examples, a channel 115 (e.g., associated signal paths and terminals) may be dedicated to communicating one or more types of information. For example, the channels 115 may include one or more command and address channels, one or more clock signal channels, one or more data channels, among other channels or combinations thereof. In some examples, signaling may be communicated via the channels 115 using single data rate (SDR) signaling or double data rate (DDR) signaling. In SDR signaling, one modulation symbol (e.g., signal level) of a signal may be registered for each clock cycle (e.g., on a rising or falling edge of a clock signal). In DDR signaling, two modulation symbols of a signal may be registered for each clock cycle (e.g., on both a rising edge and a falling edge of a clock signal).

In some examples, at least a portion of the system 100 may implement a stacked die architecture in which multiple semiconductor dies are physically and communicatively coupled. In some implementations, one or more semiconductor dies may include multiple instances of interface circuitry (e.g., of a memory system 110, memory interface blocks) that are each associated with accessing a respective set of one or more memory arrays 170 of one or more other semiconductor dies. In some cases, circuitry for accessing one or more memory arrays 170 may be distributed among multiple semiconductor dies of a stack (e.g., a stack of multiple directly-coupled semiconductor dies). For example, a first die may include a logic block (e.g., a common logic block, a central logic block, logic circuitry) operable to configure a set of multiple first interface blocks (e.g., MIBs, instances of first interface circuitry) of the first die. In some examples, the system may include a respective controller (e.g., a memory controller, a host interface controller, at least a portion of a memory system controller 155, at least a portion of an external memory controller 120, or a combination thereof) for each first interface block to support access operations (e.g., to access one or more memory arrays 170) via the first interface block. The system 100 may also include non-volatile storage, one or more sensors, or a combination thereof to support various operations of the system 100.

In accordance with examples as disclosed herein, multiple semiconductor dies of a memory system 110 (e.g., a 3D stacked memory system) may include one or more second dies (e.g., memory dies 160, array dies) stacked with a first die (e.g., a logic die that includes the host system 105, a logic die that is coupled with a third die that includes the host system 105) that includes interface blocks operable to access a set of memory arrays 170 distributed across the one or more second dies. In some cases, memory cells in the set of memory arrays 170 may be subject to adverse access operations, such as a row hammer attack. To mitigate (e.g., avoid, reduce) adverse effects resulting from row hammer attacks, the operations for row hammer mitigation may be distributed across circuitry of the system 100.

In some examples, a first interface block of the first die and a second interface block of a second die of the one or more second dies may exchange signaling to perform row hammer mitigation operations. For example, the memory system 110 may implement counters to track respective quantities of access operations (e.g., activation operations) for respective addresses of respective memory arrays 170, such as respective rows of memory cells of the respective memory arrays 170. In some examples, the second interface block may transmit alert signaling to the first interface block based on a value of a counter satisfying one or more threshold values. The first interface block may evaluate the alert signaling and may issue one or more refresh commands to the second interface block in response to the alert signaling. A refresh command may indicate one or more addresses for refreshing, such as rows (e.g., victim rows) that are neighboring (e.g., adjacent to) a row (e.g., an aggressor row) associated with the alert signaling. By exchanging signaling associated with row hammer mitigation between multiple semiconductor dies in accordance with one or more of the described techniques, a system may be configured with more robust row hammer mitigation procedures, increased security, and increased reliability, among other advantages, compared with other techniques for row hammer mitigation.

In addition to applicability in systems as described herein, interface techniques for stacked memory architectures may be generally implemented to support artificial intelligence applications. As the use of artificial intelligence increases to support machine learning, analytics, decision making, or other related applications, electronic devices that support artificial intelligence applications and processes may be desired. For example, artificial intelligence applications may be associated with accessing relatively large quantities of data for analytical purposes and may benefit from memory systems capable of effectively and efficiently storing relatively large quantities of data or accessing stored data relatively quickly. Implementing the techniques described herein may support artificial intelligence or machine learning techniques by supporting robust protection and efficient accessing of information via a relatively high quantity of closely-coupled interfaces (e.g., channels, data paths, support stacks) between a host and memory arrays of one or more semiconductor dies that are stacked over a logic die, such as by implementing robust row hammer mitigation procedures in a system that includes the stacked logic die and semiconductor dies, among other benefits.

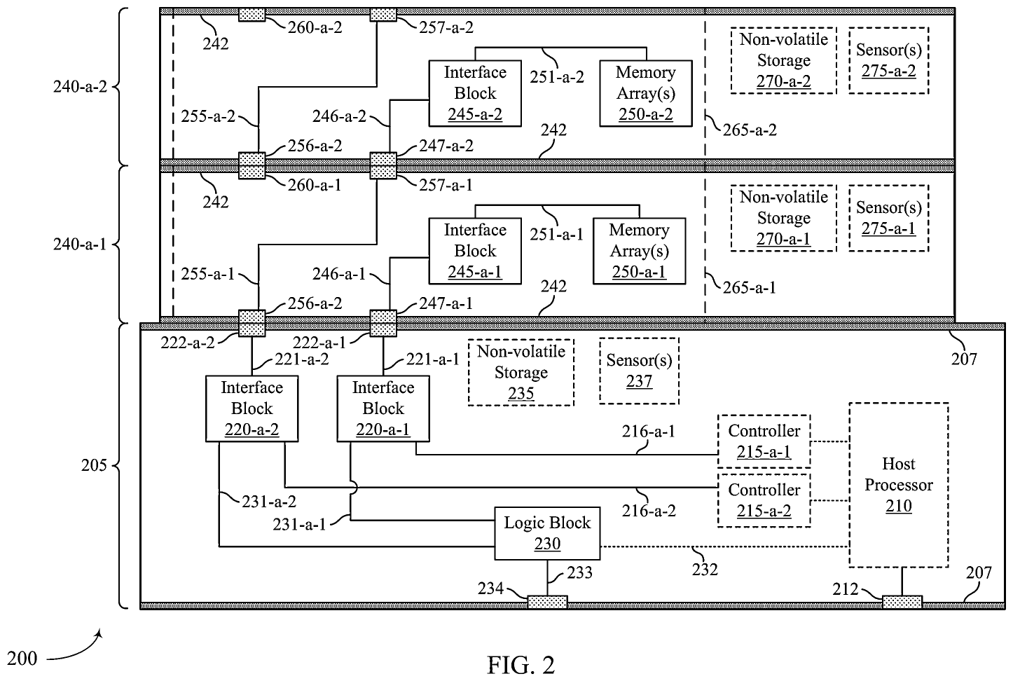

FIG. 2 illustrates an example of a system 200 (e.g., a semiconductor system, a system of coupled semiconductor dies) that supports row hammer mitigation for stacked memory architectures in accordance with examples as disclosed herein. The system 200 illustrates an example of a die 205 (e.g., a semiconductor die, a host die, a processor die, a logic die) that is coupled with one or more dies 240 (e.g., dies 240-a-1 and 240-a-2, semiconductor dies, memory dies, array dies). A die 205 or a die 240 may be formed using a respective semiconductor substrate (e.g., a substrate of crystalline semiconductor material such as silicon, germanium, silicon-germanium, gallium arsenide, or gallium nitride), or a silicon-on-insulator (SOI) substrate (e.g., silicon-on-glass (SOG), silicon-on-sapphire (SOS)), or epitaxial semiconductor materials formed on another substrate, among other examples. Although the illustrated example of a system 200 includes two dies 240, a system 200 in accordance with the described techniques may include any quantity of one or more dies 240 coupled with a die 205. Further, although non-limiting examples of the system 200 herein are generally described in terms of applicability to memory systems, memory sub-systems, memory devices, or a combination thereof, examples of the system 200 are not so limited. For example, aspects of the present disclosure may be applied as well to any computing system, computing sub-system, processing system, processing sub-system, component, device, structure, or other types of systems or sub-systems used for applications such as data collecting, data processing, data storage, networking, communication, power, artificial intelligence, system-on-a-chip, control, telemetry, sensing and monitoring, digital entertainment, or any combination thereof.

The system 200 illustrates an example of interface circuitry between a host and memory (e.g., via a host interface, via a physical host interface) that is implemented in (e.g., divided between) multiple semiconductor dies (e.g., a stack of directly coupled dies). For example, the die 205 may include a set of one or more interface blocks 220 (e.g., interface blocks 220-a-1 and 220-a-2, memory interface blocks), and each die 240 may include a set of one or more interface blocks 245 and one or more memory arrays 250 (e.g., die 240-a-1 including an interface block 245-a-1 coupled with a set of one or more memory arrays 250-a-1, die 240-a-2 including an interface block 245-a-2 coupled with a set of one or more memory arrays 250-a-2). The memory arrays 250 may be examples of memory arrays 170, and may include memory cells of various architectures, such as RAM, DRAM, SDRAM, SRAM, FeRAM, MRAM, RRAM, PCM, chalcogenide, NOR, or NAND memory cells, or any combination thereof.

Although the example of system 200 is illustrated with one interface block 245 included in each die 240, a die 240 in accordance with the described techniques may include any quantity of one or more interface blocks 245, each coupled with a respective set of one or more memory arrays 250, and each coupled with a respective interface block 220 of a die 205. Thus, the interface circuitry of a system 200 may include one or more interface blocks 220 of a die 205, with each interface block 220 being coupled with (e.g., in communication with) a corresponding interface block 245 of a die 240 (e.g., external to the die 205). In some examples, a coupled combination of an interface block 220 and an interface block 245 (e.g., coupled via a bus associated with one or more channels, such as one or more data channels, one or more control channels, one or more clock channels, or a combination thereof) may include or be referred to as a data path associated with a respective set of one or more memory arrays 250.

In some implementations, the die 205 may include a host processor 210. A host processor 210 may be an example of a host system 105, or a portion thereof (e.g., a processor 125, aspects of an external memory controller 120, or both). The host processor 210 may be configured to perform operations that implement storage of the memory arrays 250. For example, the host processor 210 may receive data read from the memory arrays 250, or may transmit data to be written to the memory arrays 250, or both (e.g., in accordance with an application or other operations of the host processor 210). Additionally, or alternatively, a host processor 210 may be external to a die 205, such as in another semiconductor die or other component that is coupled with (e.g., communicatively coupled with, directly coupled with, bonded with) the die 205 via one or more contacts 212.

A host processor 210 may be configured to communicate (e.g., transmit, receive) signaling with the interface blocks 220 via one or more host interfaces 216 (e.g., a physical host interface), which may implement aspects of channels 115 described with reference to FIG. 1. For example, the host processor 210 may be configured to transmit access signaling (e.g., control signaling, access command signaling, configuration signaling) via host interfaces 216, which may be received by the interface blocks 220 to support access operations (e.g., read operations, write operations) on the memory arrays 250. In some examples, a host interface 216 may include a respective set of one or more signal paths for each interface block 220, such that the host processor 210 may communicate with each interface block 220 via the respective set of signal paths (e.g., in accordance with a selection of the respective set to perform access operations via an interface block 220 that is selected by the host processor 210). Additionally, or alternatively, a host interface 216 may include one or more signal paths that are shared among multiple interface blocks 220 (not shown), and an interface block 220, or a host processor 210, or both may interpret, ignore, respond to, or inhibit response to signaling via shared signal paths of the host interface 216 based on a logical indication (e.g., an addressing indication associated with the interface block 220 or an interface enable signal, which may be provided by the host processor 210 or the corresponding interface block 220, depending on signaling direction).

In some examples, a respective host interface 216 may be coupled between a set of one or more interface blocks 220 and a controller 215 (e.g., host interface 216-a-1 coupled between interface block 220-a-1 and controller 215-a-1, host interface 216-a-2 coupled between interface block 220-a-2 and controller 215-a-2). The one or more interface blocks 220 and the controller 215 may communicate (e.g., collaborate) to perform one or more operations (e.g., scheduling operations, access operations, operations initiated by a host processor 210) associated with a memory array 250. A controller 215 may be an example of control circuitry (e.g., memory controller circuitry, host interface control circuitry), and may be associated with implementing respective instances of one or more aspects of an external memory controller 120, or of a memory system controller 155, or a combination thereof for each interface block 220. In some examples, controllers 215 may be implemented in a die 205 whether a host processor 210 is included in the die 205, or is external to the die 205, and the interface block 220 may communicate with the host processor 210 via one or more controllers 215. In some other examples, controllers 215 may be implemented external to a die 205 (e.g., in another die, not shown, coupled with respective interface blocks 220 via respective terminals for each of the respective host interfaces 216), which may be in a same die as or a different die from a die that includes a host processor 210. In some other examples, aspects of one or more controllers 215 may be included in the host processor 210. Although the example of system 200 is illustrated as including a controller 215 for each interface block 220, in various examples, a controller 215 may be coupled with any quantity of one or more interface blocks 220, and a given interface block 220 may be operable based on single controller 215, or by one or more of a set of multiple controllers 215 (e.g., in accordance with a controller multiplexing scheme).

In some examples, a host processor 210 may determine to access an address (e.g., a logical address of a memory array 250, a physical address of a memory array 250, an address of an interface block 220), and determine which controller 215 to transmit access signaling to for accessing the address (e.g., a controller 215 or interface block 220 corresponding to the address). In some examples, the address may be associated with a row of memory cells of the memory array 250. The host processor 210 may transmit access signaling to the determined controller 215 and, in turn, the determined controller 215 may transmit access signaling to the corresponding interface block 220. The corresponding interface block 220 may subsequently transmit access signaling to the coupled interface block 245 to access the determined address (e.g., in a corresponding memory array 250).

A die 205 may also include a logic block 230 (e.g., a shared logic block, a central logic block, common logic circuitry), which may be configured to communicate (e.g., transmit, receive) signaling with the interface blocks 220 of the die 205. In some cases, the logic block 230 may be configured to communicate information (e.g., commands, instructions, indications, data) with one or more interface blocks 220 to facilitate operations of the system 200. For example, a logic block 230 may be configured to transmit configuration signaling (e.g., initialization signaling, evaluation signaling), which may be received by interface blocks 220 to support configuration of the interface blocks 220 or other aspects of operating the dies 240 (e.g., via the respective interface blocks 245). A logic block 230 may be coupled with each interface block 220 via a respective bus 231 (e.g., bus 231-a-1 associated with the interface block 220-a-1, bus 231-a-2 associated with the interface block 220-a-2). In some examples, respective buses 231 may each include a respective set of one or more signal paths, such that a logic block 230 may communicate with each interface block 220 via the respective set of signal paths. Additionally, or alternatively, respective buses 231 may include one or more signal paths that are shared among multiple interface blocks 220 (not shown).

In some implementations, a logic block 230 may be configured to communicate (e.g., transmit, receive) signaling with a host processor 210 (e.g., via a bus 232, via a contact 212 for a host processor 210 external to a die 205) such that the logic block 230 may support an interface between the interface blocks 220 and the host processor 210. For example, a host processor 210 may be configured to transmit initialization signaling (e.g., boot commands), or other configuration or operational signaling, which may be received by a logic block 230 to support initialization, configuration, or other operations of the interface blocks 220. Additionally, or alternatively, in some implementations, a logic block 230 may be configured to communicate (e.g., transmit, receive) signaling with a component outside the system 200 via a bus 233 (e.g., and via a contact 234), such that the logic block 230 may support an interface that bypasses a host processor 210. Additionally, or alternatively, a logic block 230 may communicate with a host processor 210, and may communicate with one or more memory arrays 250 of one or more dies 240 (e.g., to perform self-test operations for the memory arrays 250). In some examples, such implementations may support evaluations, configurations, or other operations of the system 200, via contacts 234 that are accessible at a physical interface of the system, during manufacturing, assembly, validation, or other operation associated with the system 200 (e.g., before coupling with a host processor 210, without implementing a host processor 210, for operations independent of a host processor).

Each interface block 220 may be coupled with at least a respective bus 221 of the die 205, and a respective bus 246 of a die 240, that are configured to communicate signaling with a corresponding interface block 245 (e.g., via one or more associated signal paths). For example, the interface block 220-a-1 may be coupled with the interface block 245-a-1 via a bus 221-a-1 and a bus 246-a-1, and the interface block 220-a-2 may be coupled with the interface block 245-a-2 via a bus 221-a-2 and a bus 246-a-2. In some examples, a die 240 may include a bus that bypasses operational circuitry of the die 240 (e.g., bypasses interface blocks 245 of a given die 240), such as a bus 255. For example, the interface block 220-a-2 may be coupled with the interface block 245-a-2 of the die 240-a-2 via a bus 255-a-1 of the die 240-a-1, which may bypass interface blocks 245 of the die 240-a-1. Such techniques may be extended for interconnection among more than two dies 240 (e.g., for interconnection via a respective bus 255 of multiple dies 240).

The respective signal paths of buses 221, 246, and 255 may be coupled with one another, from one die to another, via various arrangements of contacts at the surfaces of interfacing dies. For example, the bus 221-a-1 may be coupled with the bus 246-a-1 via a contact 222-a-1 of (e.g., at a surface of) the die 205 and a contact 247-a-1 of the die 240-a-1, the bus 221-a-2 may be coupled with the bus 255-a-1 via a contact 222-a-2 of the die 205 and a contact 256-a-1 of the die 240-a-1, the bus 255-a-1 may be coupled with the bus 246-a-2 via a contact 257-a-1 of the die 240-a-1 and a contact 247-a-2 of the die 240-a-2, and so on. Although each respective bus is illustrated with a single line, coupled via singular contacts, it is to be understood that each signal path of a given bus may be associated with respective contacts to support a separate communicative coupling via each signal path of the given bus. In some examples, a bus 255 may traverse a portion of a die 240 (e.g., in an in-plane direction, along a direction different from a thickness direction, in a waterfall arrangement), which may support an arrangement of contacts 222 along a surface of a die 205 being coupled with interface blocks 245 of different dies 240 along a stack direction (e.g., via respective contacts 256 and 257 that are non-overlapping when viewed along a thickness direction).

The interconnection of interfacing contacts may be supported by various techniques. For example, in a hybrid bonding implementation, interfacing contacts may be coupled by a fusion of conductive materials (e.g., electrically conductive materials) of the interfacing contacts (e.g., without solder or other intervening material between contacts). For example, in an assembled condition, the coupling of the die 205 with the die 240-a-1 may include a conductive material of the contact 222-a-2 being fused with a conductive material of the contact 256-a-1, and the coupling of the die 240-a-1 with the die 240-a-2 may include a conductive material of the contact 257-a-1 being fused with a conductive material of the contact 247-a-2, and so on. In some examples, such coupling may include an inoperative fusion of contacts (e.g., a non-communicative coupling, a physical coupling), such as a fusion of the contact 260-a-1 with the contact 256-a-2, neither of which are coupled with operative circuitry of the dies 240-a-1 or 240-a-2. In some examples, such techniques may be implemented to improve coupling strength or uniformity (e.g., implementing contacts 260, which may not be operatively coupled with an interface block 245 or an interface block 220), or such a coupling may be a byproduct of a repetition of components that, in various configurations, may be operative or inoperative. (e.g., where, for dies 240 with a common arrangement of contacts 256 and 257, contacts 256-a-1 and 257-a-1 provide a communicative path between the interface block 245-a-2 and the interface block 220-a-2, but the contacts 256-a-2 and 257-a-2 do not provide a communicative path between an interface block 245 and an interface block 220).

In some examples, a fusion of conductive materials between dies (e.g., between contacts) may be accompanied by a fusion of other materials at one or more surfaces of the interfacing dies. For example, in an assembled condition, the coupling of the die 205 with the die 240-a-1 may include a dielectric material 207 (e.g., an electrically non-conductive material) of the die 205 being fused with a dielectric material 242 of the die 240-a-1, and the coupling of the die 240-a-1 with the die 240-a-2 may include a dielectric material 242 of the die 240-a-1 being fused with a dielectric material 242 of the die 240-a-2. In some examples, such dielectric materials may include an oxide, a nitride, a carbide, an oxide-nitride, an oxide-carbide, or other conversion or doping of a semiconductor material of the die 205 or dies 240, among other materials that may support such fusion. However, coupling among dies 205 and dies 240 may be implemented in accordance with other techniques, which may implement solder, adhesives, thermal interface materials, and other intervening materials.

In some examples, dies 240 may be coupled in a stack (e.g., forming a “cube” or other arrangement of dies 240), and the stack may subsequently be coupled with a die 205. In some examples, a respective set of one or more dies 240 may be coupled with each die 205 of multiple dies 205 formed in a wafer (e.g., in a chip-to-wafer bonding arrangement, before cutting the wafer of dies 205), and the dies 205, coupled with their respective set of dies 240, may be separated from one another (e.g., by cutting at least the wafer of dies 205). In some other examples, a respective set of one or more dies 240 may be coupled with a respective die 205 after the die 205 is separated from a wafer of dies 205 (e.g., in a chip-to-chip bonding arrangement).

The buses 221, 246, and 255 may be configured to provide a configured signaling (e.g., a coordinated signaling, a logical signaling, modulated signaling, digital signaling, one or more signals) between an interface block 220 and a corresponding interface block 245, which may involve various modulation or encoding techniques by a transmitting interface block (e.g., via a driver component of the transmitting interface block). In some examples, such signaling may be supported by (e.g., accompanied by) clock signaling communicated via the respective buses (e.g., in coordination with signal transmission). For example, the buses may be configured to convey one or more clock signals transmitted by the interface block 220 for reception by the interface block 245 (e.g., to trigger signal reception by a latch or other reception component of the interface block 245, to support clocked operations of the interface block 245). Additionally, or alternatively, the buses may be configured to convey one or more clock signals transmitted by the interface block 245 for reception by the interface block 220 (e.g., to trigger signal reception by a latch or other reception component of the interface block 220, to support clocked operations of the interface block 220). Such clock signals may be associated with the communication (e.g., unidirectional communication, bidirectional communication) of various signaling, such as control signaling, command signaling, data signaling, or any combination thereof. For example, the buses may include one or more signal paths for communications of a data bus (e.g., one or more data channels, a DQ bus, via a data interface of the interface blocks) in accordance with one or more corresponding clock signals (e.g., data clock signals), or one or more signal paths for communications of a control bus (e.g., a command/address (C/A) bus, via a command interface of the interface blocks) in accordance with one or more clock signals (e.g., control clock signals), or any combination thereof.

Interface blocks 220, interface blocks 245, and logic block 230 each may include circuitry (signaling circuitry, multiplexing circuitry, processing circuitry, controller circuitry) in various configurations (e.g., hardware configurations, logic configurations, software or instruction configurations) that support the functionality allocated to the respective block for accessing or otherwise operating a corresponding set of memory arrays 250. For example, interface blocks 220 may include circuitry configured to perform a first subset of operations that support access of the memory arrays 250, and interface blocks 245 may include circuitry configured to support a second subset of operations that support access of the memory arrays 250. In some examples, the interface blocks 220 and 245 may support a functional split or distribution of functionality associated with a memory system controller 155, a local memory controller 165, or both across multiple dies (e.g., a die 205 and at least one die 240). In some implementations, a logic block 230 may be configured to coordinate or configure aspects of the operations of the interface blocks 220, of the interface blocks 245, or both, and may support implementing one or more aspects of a memory system controller 155. Such operations, or subsets of operations, may include operations performed in response to commands from the host processor 210, or operations performed without commands from the host processor 210 (e.g., operations determined or initiated by an interface block 220, operations determined or initiated by an interface block 245, operations determined or initiated by a logic block 230), or various combinations thereof.

In some implementations, the system 200 may include one or more instances of non-volatile storage (e.g., non-volatile storage 235 of a die 205, non-volatile storage 270 of one or more dies 240, or a combination thereof). In some examples, a logic block 230, interface blocks 220, interface blocks 245, or a combination thereof may be configured to communicate signaling with one or more instances of non-volatile storage. For example, a logic block 230, interface blocks 220, or interface blocks 245 may be coupled with one or more instances of non-volatile storage via one or more buses (not shown), or respective contacts (not shown), where applicable, which may each include one or more signal paths operable to communicate signaling (e.g., command signaling, data signaling). In some examples, a logic block 230, one or more interface blocks 220, one or more interface blocks 245, or a combination thereof may configure one or more operations based on information stored in one or more instances of non-volatile storage. Additionally, or alternatively, in some examples, a logic block 230, one or more interface blocks 220, one or more interface blocks 245, or a combination thereof may write information (e.g., configuration information) to be stored in one or more instances of non-volatile storage.

In some implementations, the system 200 may include one or more sensors (e.g., one or more sensors 237 of a die 205, one or more sensors 275 of one or more dies 240, or a combination thereof). In some implementations, a logic block 230, interface blocks 220, interface blocks 245, or a combination thereof may be configured to receive one or more indications based on measurements of one or more sensors of the system 200. For example, a logic block 230, interface blocks 220, or interface blocks 245 may be coupled with one or more sensors via one or more buses (not shown), or respective contacts (not shown). Such sensors may include temperature sensors, current sensors, voltage sensors, counters, and other types of sensors. In some examples, a logic block 230, one or more interface blocks 220, one or more interface blocks 245, or a combination thereof may configure one or more operations based on output of the one or more sensors. For example, a logic block 230 may configure one or more operations of interface blocks 220 based on signaling (e.g., indications, data) received from the one or more sensors. Additionally, or alternatively, an interface block 220 may generate access signaling for transmitting to a corresponding interface block 245 based on one or more sensors.

In some examples, circuitry of interface blocks 220, interface blocks 245, or a logic block 230, or any combination thereof may include components (e.g., transistors) formed at least in part from doped portions of a substrate of the respective die. In some examples, a substrate of a die 205 may have characteristics that are different from those of a substrate of a die 240. Additionally, or alternatively, in some examples, transistors formed from a substrate of a die 205 may have characteristics that are different from transistors formed from a substrate of a die 240 (e.g., in accordance with different transistor architectures).

In some examples, the interface blocks 220 may support a layout for one or more components within the 220. For example, the layout may include pairing components to share an access port (e.g., a command port, a data port). Further, in some examples, the layout may support interfaces for a controller 215 (e.g., a host interface 216) that are different from interfaces for an interface block 245 (e.g., via the buses 221). For instance, a host interface 216 may be synchronous and have separate channels for read and write operations, while an interface via buses 221 and 246 may be asynchronous and support both read and write operations with a same channel.

A die 240 may include one or more units 265 (e.g., modules) that are separated from a semiconductor wafer having a pattern (e.g., a two-dimensional pattern) of units 265. Although each die 240 of the system 200 is illustrated with a single unit 265 (e.g., unit 265-a-1 of die 240-a-1, unit 265-a-2 of die 240-a-2), a die 240 in accordance with the described techniques may include any quantity of units 265, which may be arranged in various patterns (e.g., sets of one or more units 265 along a row direction, sets of one or more units 265 along a column direction, among other patterns). Each unit 265 may include at least the circuitry of a respective interface block 245, along with memory array(s) 250, a bus 251, a bus 246, and one or more contacts 247 corresponding to the respective interface block 245. In some examples, where applicable, each unit 265 may also include one or more buses 255, contacts 256, contacts 257, or contacts 260 (e.g., associated with a respective interface block 245 of a unit 265 of a different die 240), which may support various degrees of stackability or modularity among or via units 265 of other dies 240.

In some examples, the interface blocks 220 may include circuitry configured to receive first access command signaling from a host processor 210 or a controller 215 (e.g., via a host interface 216, via one or more contacts 212 from a host processor 210 or controller 215 external to a die 205), and to transmit second access command signaling to the respective (e.g., coupled) interface block 245 based on (e.g., in response to) the received first access command signaling. The interface blocks 245 may accordingly include circuitry configured to receive the second access command signaling from the respective interface block 220 and, in some examples, to access a respective set of one or more memory arrays 250 based on (e.g., in response to) the received second access command signaling. In various examples, the first access command signaling may include access commands that are associated with a type of operation (e.g., a read operation, a write operation, a refresh operation, a memory management operation), which may be associated with an indication of an address of the one or more memory arrays 250 (e.g., a logical address, a physical address). In some examples, the first access command signaling may include an indication of a logical address associated with the memory arrays 250, and circuitry of an interface block 220 may be configured to generate the second access command signaling to indicate a physical address associated with the memory arrays 250 (e.g., a row address, a column address, using a logical-to-physical (L2P) table or other mapping or calculation functionality of the interface block 220).

In some examples, to support write operations of the system 200, circuitry of the interface blocks 220 may be configured to receive (e.g., from a host processor 210, from a controller 215, via a host interface 216, via one or more contacts 212 from a host processor 210 or controller 215 external to a die 205) first data signaling associated with the first access command signaling, and to transmit second data signaling (e.g., associated with second access command signaling) based on received first access command signaling and first data signaling. The interface blocks 245 may accordingly be configured to receive second data signaling, and to write data to one or more memory arrays 250 (e.g., in accordance with an indicated address associated with the first access command signaling) based on the received second access command signaling and second data signaling. In some examples, the interface blocks 220 may include an error control functionality (e.g., error detection circuitry, error correction circuitry, error correction code (ECC) logic, an ECC engine) that supports the interface blocks 220 generating the second data signaling based on performing an error control operation using the received first data signaling (e.g., detecting or correcting an error in the first data signaling, determining one or more parity bits to be conveyed in the second data signaling and written with the data).

In some examples, to support read operations of the system 200, circuitry of the interface blocks 245 may be configured to read data from the memory arrays 250 based on received second access command signaling, and to transmit first data signaling based on the read data. The interface blocks 220 may accordingly be configured to receive first data signaling, and to transmit second data signaling (e.g., to a host processor 210, to a controller 215, via a host interface 216, via one or more contacts 212 to a host processor 210 or controller 215 external to a die 205) based on the received first data signaling. In some examples, the interface blocks 220 may include an error control functionality that supports the interface blocks 220 generating the second data signaling based on performing an error control operation using the received first data signaling (e.g., detecting or correcting an error in the first data signaling, which may include a calculation involving one or more parity bits received with the first data signaling).

In some examples, access command signaling that is transmitted by the interface blocks 220 to the interface blocks 245, among other signaling, may be generated (e.g., based on access command signaling received from a host processor 210, based on initiation signaling received from a host processor 210, without receiving or otherwise independent from signaling from a host processor 210) in accordance with various determination or generation techniques configured at the interface blocks 220 (e.g., based on a configuration for accessing memory arrays 250 that is modified at the interface blocks 220). In some examples, such techniques may involve signaling or other coordination with a logic block 230, a host processor 210, one or more controllers 215, one or more instances of non-volatile storage, one or more sensors, or any combination thereof. Such techniques may support the interface blocks 220 configuring aspects of the access operations performed on the memory arrays 250 by a respective interface block 245, among other operations. For example, interface blocks 220 may include evaluation circuitry, access configuration circuitry, signaling circuitry, scheduling circuitry, repair circuitry, refresh circuitry, error control circuitry, adverse access circuitry, and other circuitry operable to configure operations associated with one or more dies (e.g., operations associated with accessing memory arrays 250 of the dies 240).

In some cases, memory cells in the memory arrays 250 may be subject to adverse access operations, such as a row hammer attack, which may modify (e.g., compromise, corrupt) data stored by the memory cells. As part of a row hammer attack, a row of memory cells (e.g., an aggressor row) of a memory array 250 may undergo repeated (e.g., a quantity exceeding a threshold) access operations, such as within a relatively short duration. To reduce adverse effects associated with row hammer attacks, the system 200 may distribute operations for row hammer mitigation across multiple dies of the system 200, such across a die 205 and one or more dies 240. For instance, an interface block 220 and an interface block 245 may exchange signaling to perform row hammer mitigation operations. For example, the system 200 may utilize counters (e.g., at or coupled with a memory array 250) to track quantities of access operations on (e.g., activations of) respective rows of one or more memory arrays 250. In some examples, the interface block 245 may transmit alert signaling to the interface block 220 based on a value of one of the counters satisfying one or more threshold values. The interface block 220 may evaluate the received alert signaling and may issue one or more refresh commands to the interface block 245 in response to the alert signaling. For example, the alert signaling may include a value that indicates which of the one or more thresholds is satisfied by the value of the counter or whether there is an error associated with the counter. A refresh command may indicate one or more rows (e.g., victim rows) for refreshing that are neighbors (e.g., adjacent) to a row associated with the alert signaling (e.g., an aggressor row). By exchanging signaling associated with row hammer mitigation between multiple semiconductor dies in accordance with one or more of the described techniques, interfacing circuitry of the multiple semiconductor dies may support row hammer mitigation within a 3D stacked memory system and may be configured with more robust row hammer mitigation procedures, increased reliability, among other advantages, compared with other techniques for row hammer mitigation.

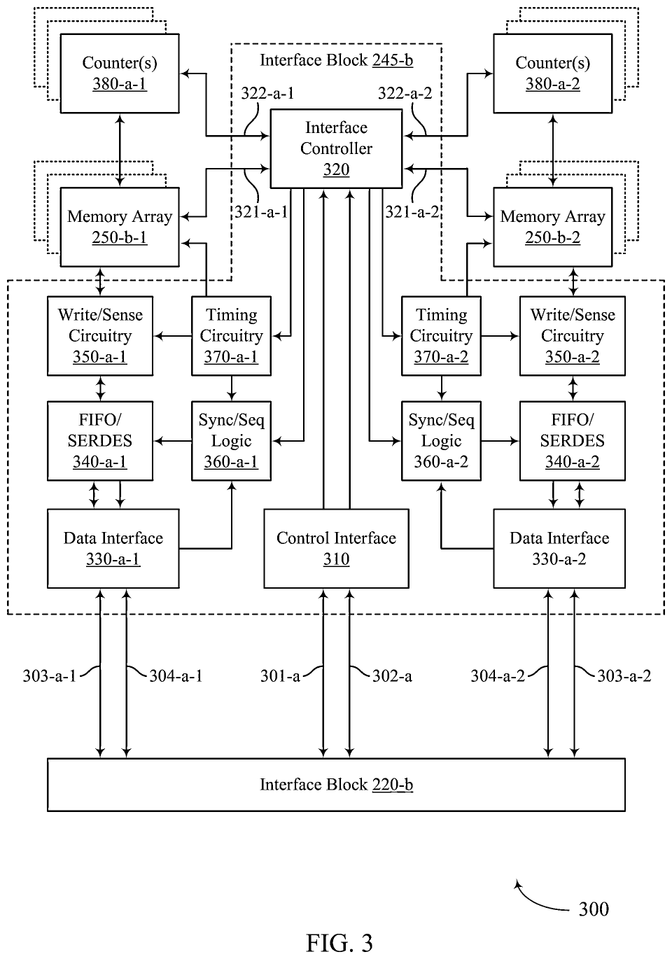

FIG. 3 illustrates an example of an interface architecture 300 that supports row hammer mitigation for stacked memory architectures in accordance with examples as disclosed herein. The interface architecture 300 illustrates an example of an interface block 245-b (e.g., of a die 240) coupled with an interface block 220-b (e.g., of a die 205). The interface block 245-b may be communicatively coupled with the interface block 220-b via one or more of a bus 301, a bus 302, a bus 303, and a bus 304, each of which may be examples of one or more signal paths of a bus 221 and a bus 246, as well as a bus 255, where applicable.

The interface block 245-b includes a control interface 310 (e.g., a command interface), which may be configured to communicate signaling with the interface block 220-b. For example, the control interface 310 may include circuitry (e.g., a receiver, one or more latches) configured to receive control signaling (e.g., modulated control signaling, access command signaling, configuration signaling, address signaling, such as row address signaling or column address signaling) via the bus 301-a. The control interface 310 also may include circuitry configured to receive clock signaling (e.g., clock signaling associated with the control interface 310, clock signaling having one or more phases, such as true and complement phases, dk_t/c signaling from the interface block 220-b) via the bus 302-a, which the control interface 310 may use for receiving the control signaling of the bus 301-a (e.g., for triggering the one or more latches). The control interface 310 may transmit (e.g., forward) the control signaling the clock signaling (e.g., for timing of other operations of the interface block 245-b) to an interface controller 320.

The interface block 245-b also includes two data interfaces 330 (e.g., data interfaces 330-a-1 and 330-a-2), which also may be configured to communicate signaling with the interface block 220-b. Each data interface 330 may include corresponding buses and circuitry, the operation of which may be associated with (e.g., controlled by, coordinated with, operated based on) control signaling via the control interface 310. Although the example of interface block 245-b includes two such data interfaces 330 associated with the control interface 310 (e.g., in a “channel pair” arrangement), the described techniques for an interface block 245 may include any quantity of one or more data interfaces 330, and associated buses and circuitry, for a given control interface 310 of the interface block 245. Each data interface 330 may be associated with respective data path circuitry, which may include respective first-in-first-out (FIFO) and serialization/deserialization (SERDES) circuitry (e.g., FIFO/SERDES 340), respective write/sense circuitry 350, respective synchronization and sequencing circuitry (e.g., sync/seq logic 360), and respective timing circuitry 370, along with interconnecting signal paths (e.g., one or more buses). However, in some other examples, data path circuitry may be arranged in a different manner, or may include different circuitry components, which may include circuitry that is dedicated to respective data paths, or shared among data paths, or various combinations thereof. Each data interface 330 also may be associated with a respective set of one or more memory arrays 250. In some examples, each memory array 250 may be understood to include respective addressing circuitry such as bank logic or decoders (e.g., a row decoder, a column decoder), among other array circuitry. However, in some other examples, at least a portion of such circuitry may be included in an interface block 245.

Each data interface 330 may include circuitry (e.g., one or more latches, one or more drivers) configured to communicate (e.g., receive, transmit) data signaling (e.g., modulated data signaling, DQ signaling) via a respective bus 303. Each data interface 330 also may include circuitry to communicate clock signaling via a respective bus 304, which may support clock signal reception by the data interface 330 (e.g., first clock signaling associated with the data interface 330, clock signaling having one or more phases, such as true and complement phases, DQS_t/c signaling from the interface block 220-b, clock signaling associated with data reception or write operations), or clock signal transmission by the data interface 330 (e.g., second clock signaling associated with the data interface 330, RDQS_t/c signaling to the interface block 220-b, clock signaling associated with data transmission or read operations), or both. Each data interface 330 may transmit clock signaling (e.g., received clock signaling, DQS_t/c signaling) to sync/seq logic 360 via a respective bus (e.g., for timing of other operations of the interface block 245-b).

The interface controller 320 may support various control or configuration functionality of the interface block 245-b for accessing or otherwise managing operations of the coupled memory arrays 250. For example, the interface controller 320 may support access command coordination or configuration, latency or timing compensation, access command buffering (e.g., in accordance with a FIFO or other organizational scheme), mode registers or logic for configuration settings, or test functionality, among other functions or combinations thereof. For each data path of the interface block 245 (e.g., associated with a respective data interface 330), the interface controller 320 may be configured to transmit signaling to the respective memory arrays 250 via a bus 321 (e.g., address signaling, such as a row address or row activation signaling). For each data path of the interface block 245, the interface controller 320 may communicate signaling (e.g., timing signaling, which may be based on clock signaling received from the control interface 310, configuration signaling) with respective timing circuitries 370 and sync/seq logic 360 via respective buses.

For each data path, the respective timing circuitry 370 may support timing of various operations (e.g., activations, coupling operations, signal latching, signal driving) relative to timing signaling received from the interface controller 320. For example, timing circuitry 370 may include a timing chain (e.g., a global column timing chain) configured to generate one or more clock signals or other initiation signals for controlling operations of the respective data path, and such signaling may include transitions (e.g., rising edge transitions, falling edge transitions, on/off transitions) that are offset from, at a different rate than, or otherwise different from transitions of signaling from the interface controller 320 to support a given operation or combination of operations. For example, timing circuitry 370 may be configured to transmit signaling (e.g., column selection signaling, column address signaling) to the respective memory arrays 250, to transmit signaling to the respective write/sense circuitry 350 (e.g., latch or driver timing signaling), and to transmit signaling to the respective sync/seq logic (e.g., timing signaling).

For each data path, the respective FIFO/SERDES 340 may be configured to convert between data signaling of a first bus width (e.g., a relatively wide bus width, a data read/write (DRW) bus, a bus for communications with write/sense circuitry 350 having a relatively larger quantity of signal paths) and a second bus width (e.g., a relatively narrow bus width, a bus for communications with a data interface 330 having a relatively smaller quantity of signal paths). In some examples, such a conversion may be accompanied by changing a rate of signaling between signaling from the data interface 330 and the write/sense circuitry 350 (e.g., to maintain a given throughput). In various examples, the FIFO/SERDES 340 may receive data signaling from the data interface 330 and transmit data signaling to the write/sense circuitry 350 (e.g., to support a write operation), or may receive data signaling from the sense circuitry 350 and transmit data signaling to the data interface 330 (e.g., to support a read operation). In some examples (e.g., to support a read operation), the FIFO/SERDES 340 may be configured to transmit clock signaling (e.g., RDQS_t/c signaling) to the data interface 330, which may be forwarded to the interface block 220-b.

The timing or other synchronization of operations performed by the FIFO/SERDES 340 may be supported by one or more clock signals, among other signaling, received from the respective sync/seq logic 360. For example, the sync/seq logic 360 may generate or otherwise coordinate clock signaling to support the different rates of signaling of different buses (e.g., based on received clock signaling). Additionally, or alternatively, the FIFO/SERDES 340 may operate in a direction (e.g., for data transmission to a data interface 330, for data reception from a data interface 330) or other mode based on configuration signaling received from the sync/seq logic 360.

For each data path, the respective write/sense circuitry 350 may be configured to support the accessing (e.g., data signaling, write signaling, read signaling) of the respective set of one or more memory arrays 250. For example, the write/sense circuitry 350 may be coupled with the memory arrays 250 via a bus (e.g., a global input/output (GIO) bus), which may include respective signal paths associated with each memory array 250, or may include signal paths that are shared for all of the memory arrays 250 of the set, in which case the memory array circuitry may include multiplexing circuitry operable to couple the bus with a selected one of the memory arrays 250. In some examples, a bus between the write/sense circuitry and the set of one or more memory arrays 250 may include a same quantity of signal paths as a bus between the write/sense circuitry 350 and the FIFO/SERDES 340 (e.g., for signaling GIO[287:0]) or a same quantity of signal paths as a quantity of columns in each memory array 250. In some other examples, the memory arrays 250 may include a quantity of columns that is an integer multiple of the quantity of signal paths of the bus, in which case the memory array circuitry (e.g., each memory array 250) may include decoding circuitry operable to couple a subset of columns of memory cells, or associated circuitry, with the bus.

To support write operations, the write/sense circuitry 350 may be configured to drive signaling that is operable to write one or more logic states to memory cells of the memory arrays 250 (e.g., based on received data, based on received timing signaling, based on data signaling received via a bus 303 and on control signaling received via a bus 301-a). In some examples, such signaling may be transmitted to supporting circuitry of or otherwise associated with the memory arrays 250 (e.g., as an output of signals corresponding to logic states to be written), such as sense amplifier circuitry, voltage sources, current sources, or other driver circuitry operable to apply a bias across a storage element of the memory cells (e.g., across a capacitor, across a ferroelectric capacitor), or apply a charge, a current, or other signaling to a storage element of the memory cells (e.g., to apply a current to a chalcogenide or other configurable memory material, to apply a charge to a gate of a NAND memory cell), among other examples.

To support read operations, the write/sense circuitry 350 may be configured to receive signaling that the write/sense circuitry 350 may further amplify for communication through the interface block 245-b. For example, the write/sense circuitry 350 may be configured to receive signaling corresponding to logic states read from the memory arrays 250, but at a relatively low driver strength (e.g., relatively ‘analog’ signaling, which may be associated with a relatively low drive strength of sense amplifiers of the memory arrays 250). The write/sense circuitry 350 may thus include further sense amplification (e.g., a data sense amplifier (DSA) between signal paths between the write/sense circuitry and the set of one or more memory arrays and respective signal paths between the write/sense circuitry and the FIFO/SERDES), which each may have a relatively high drive strength (e.g., for driving relatively ‘digital’ signaling).

The features of the interface architecture 300 may be duplicated in various quantities and arrangements to support a semiconductor system having multiple dies, such as various examples of a system 200. In an example implementation, each die 240 may be configured with 64 instances of the interface block 245-b, which may support a data signaling width of 9,216 signal paths for each die 240 (e.g., where each bus 303 of a channel pair is associated with 72 signal paths). For a system 200 having a stack of eight dies 240 coupled with a die 205, the die 205 may thus be configured with 512 instances of the interface block 220-b, thereby supporting an overall data signaling width of 73,738 signal paths for the system 200. However, in other implementations, dies 205 and dies 240 may be configured with different quantities of interface blocks 220 and 245, respectively, and a system 200 may be configured with different quantities of dies 240 per die 205.

In some examples, each memory array 250 may be organized with rows of memory cells, each row associated with an address of the memory array 250. Each memory array 250 may be associated with (e.g., coupled with, include) a set counters 380 (e.g., located in a die 240). A set of counters 380 may track access operations associated with the memory array 250 and may include a respective counter 380 for each row of the memory array 250. For example, each counter 380 may track a respective quantity of access operations on (e.g., activations of) a respective row of the memory array 250. In some examples, the interface controller 320 may operate (e.g., read, increment, write, reset) the counters 380 via the bus 321. Additionally, or alternatively, the interface controller 320 may operate the counters 380 via a dedicated bus 322 (e.g., a dedicated GIO bus, dedicated access lines). By tracking quantities of access operations on the memory arrays 250, the counters 380 may be used by the interface controller 320 to detect row hammer attacks on the memory arrays 250. For example, the interface controller 320 may compare a value of a counter 380 to one or more threshold values and determine, based on the comparison, that a row associated with the counter 380 is under row hammer attack based on the value satisfying at least one of the one or more threshold values.

In some examples, the interface block 220-b and the interface block 245-b may exchange signaling (e.g., via one or more signal paths of the bus 301, via one or more alert pins of the bus 301) to perform row hammer mitigation operations. For example, the interface block 245-b (e.g., the interface controller 320) may detect a row hammer attack associated with a memory array 250 (e.g., on a row of the memory array 250) and may transmit alert signaling to the interface block 220-b. The interface block 220 may evaluate the received alert signaling and may issue one or more refresh commands (e.g., via the bus 301) to the interface block 245-b in response to the alert signaling. A refresh command may indicate for the interface block 245-b (e.g., the interface controller 320) to refresh one or more rows (e.g., victim rows) of the memory array 250 that are neighboring to a row associated with the alert signaling (e.g., an aggressor row) based on a value included in the alert signaling. By exchanging signaling associated with row hammer mitigation between multiple semiconductor dies (e.g., a die 205 and one or more dies 240) in accordance with one or more of the described techniques, a system may support row hammer mitigation within a 3D stacked memory system and may be configured with more robust row hammer mitigation procedures, increased reliability, among other advantages, compared with other techniques for row hammer mitigation.

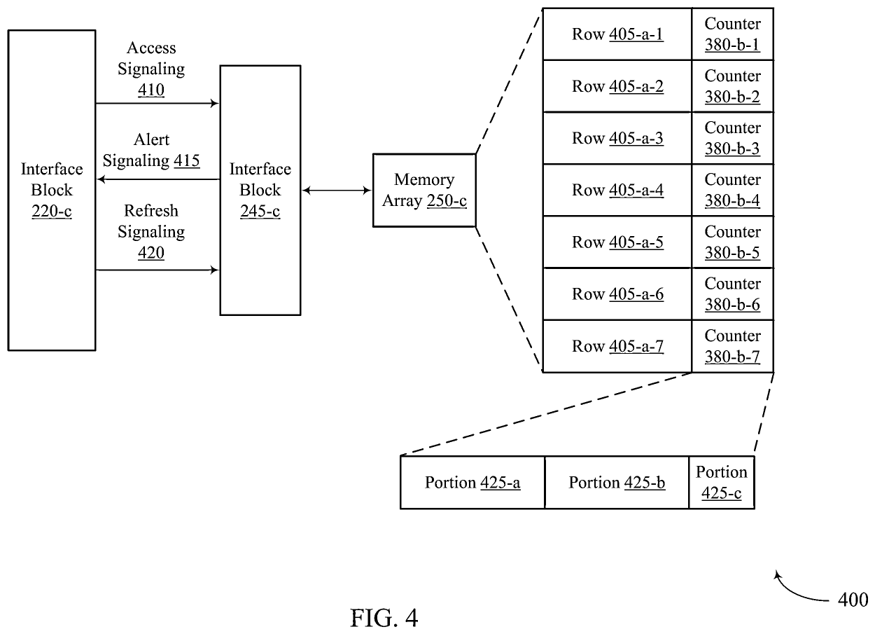

FIG. 4 shows an example of a block diagram of a system 400 that supports row hammer mitigation for stacked memory architectures in accordance with examples as disclosed herein. The system 400 illustrates an example of an interface block 245-c (e.g., of a die 240) coupled with an interface block 220-c (e.g., of a die 205). The interface block 245-c may be communicatively coupled with the interface block 220-c. The interface block 245-c may be coupled with one or more memory arrays 250, including a memory array 250-c. The one or more memory arrays 250 may each include multiple rows 405 (e.g., rows 405-a-1 through 405-a-7), and each row 405 may include a set of memory cells. Each row 405 of the one or more memory arrays 250 may be associated with a respective counter 380-b (e.g., counters 380-b-1 through a counter 380-b-7, corresponding to rows 405-a-1 through 405-a-7). The interface block 245-c and the interface block 220-c may communicate signaling (e.g., access signaling 410, alert signaling 415, refresh signaling 420, or other signaling, such as via a bus 301) to support row hammer mitigation procedures as described herein to increase system security and reliability, for example, by protecting data stored at the memory array 250-c from undesired or malicious data modification.

In some cases, the system 400 may be subject to row hammer attacks, where a large quantity of access commands (e.g., via an interface block 220-c, within a relatively small amount of time) are issued to a row 405 of a memory array 250, which may be referred to as an aggressor row 405. Due to the successive access commands, electrical charge from the aggressor row 405 may leak to or from one or more memory cells of other rows 405 nearby the aggressor row 405 (e.g., neighboring rows 405 not associated with an address in the access command), which may be referred to as victim rows 405. An electrical charge leakage or other associated disturbance may affect the state (e.g., the electrical charge) of the memory cells in the victim rows, which may lead to modification of data stored in the memory cells of the victim rows. Thus, the system 400 may perform row hammer mitigations procedures to reduce (e.g., avoid) such adverse effects, which may include refreshing the state (e.g., logic state, electrical state) of the memory cells of the victim rows (e.g., to restore their correct state).

According to techniques described herein, an interface block 245-c and an interface block 220-c may communicate signaling (e.g., one or more signals) to perform one or more mitigation procedures, for example, to support row hammer mitigation in systems where memory access circuitry is divided among multiple semiconductor dies (e.g., 3D stacked memory systems). For example, the interface block 220-c may transmit access signaling 410 (e.g., an activate (ACT) command, an access command, one or more signals, an access signal) that indicates to the interface block 245-c to activate a row 405-a of the memory array 250-c (e.g., of a die 240, as part of an access operation on the row 405-a). In some examples, the access signaling 410 may indicate parameters (e.g., a pseudo-channel (PC), a bank address, a row address) associated with the row 405-a to be activated. For example, a bus 221 via which the interface block 220-c and the interface block 245-c communicate may include multiple PCs, where different PCs may be associated with common command signal paths and respective data signal paths. For instance, a first PC and a second PC of the bus 221 may share the same command signal paths (e.g., a bus 301, a bus 302) but may include separate data signal paths (e.g., buses 303, buses 304). To indicate (e.g., identify) the row 405-a for activation, the parameters of the access signaling 410 may indicate the PC via which the row 405-a is accessed, the bank address of the bank that includes the row 405-a, and the row address of the row 405-a within the bank.

In accordance with the access signaling 410, the interface block 245-c may activate the row 405-a of the memory array 250-c, such as part of or independent of an access operation on the row 405-a. Each counter 380-b may be used (e.g., maintained, incremented) to track (e.g., count) a respective quantity of activations of (e.g., a respective quantity of access operations on) a corresponding row 405-a. For example, the counters 380-b may be implemented as per-row counters to count respective quantities of activations of each row 405-a. For example, the counter 380-b-1 may be used to track a quantity of activations of the row 405-a-1, the counter 380-b-2 may be used to track a quantity of activations of the row 405-a-2, and so on. Accordingly, based on accessing the row 405-a, the interface block 245-c may read a value of the counter 380-b used to track the quantity of activations of the row 405-a and may increment the value. The interface block 245-c may compare the value of the counter 380-b to one or more threshold values and may generate alert signaling 415 (e.g., row hammer alert signaling, one or more signals, an alert signal) based on the comparison. For example, based on the comparison, the interface block 245-c may determine whether the value of the counter 380-b satisfies one of the one or more threshold values. In some examples, the interface block 245-c may write the incremented value back to the counter 380-b. In some other examples, if the value of the counter satisfies one of the one or more threshold values, the interface block 245-c may reset at least a portion of the counter 380-b. In some cases, the interface block 245-c may detect an error associated with the value of the counter 380-b based on reading the value of the counter. In some such examples, the interface block 245-c may generate the alert signaling 415 based on detecting the error and may reset the counter 380-b.

In some cases, the interface block 245-c may implement one or more procedures associated with the counter 380-b (e.g., reading the counter 380-b, incrementing the counter 380-b, transmitting the alert signaling 415, writing the counter 380-b, resetting one or more portions of the counter 380-b) concurrently with one or more access operations associated with processing (e.g., servicing) the access signaling 410 request (e.g., performing a read operation or a write operation on the row 405-a). For example, the interface block 245-c may perform one or more access operations on the row 405-a concurrent with performing one or more operations to track a respective quantity of activations of (e.g., access operations on) the row 405-a.

To perform an access operation on the row 405-a, the interface block 245-c may issue signaling (e.g., to write/sense circuitry 350-a), such as row activation signaling, column activation signaling, or a combination thereof. In some cases, a duration between successively signaled row activations by the interface block 245-c may be based on the internal operations of the interface block 245-c associated with the counter 380-b (e.g., per-row internal operations). For example, the operations of reading a value of a counter 380-b, incrementing the value of the counter 380-b, and writing the incremented value to the counter 380-b may cause an increase in the duration (e.g., by an additional 8 nanoseconds) between successively issued row activations. Thus, in some examples, to accommodate performing the internal operations associated with the counter 380-b, the interface block 245-c may delay issuing subsequent row activation signaling at least until the internal operations (e.g., writing the incremented value to the counter 380-b) are complete.

In some examples, the counters 380-b may be multi-bit (e.g., 14 bit) counters, and different subsets of bits of the counters 380-b may be used to determine whether a value of a counter 380-b satisfies one or more threshold values or to identify an error associated with the counter 380-b. For example, each counter 380-b may include multiple portions 425 (e.g., a portion 425-a, a portion 425-b, a portion 425-c) that correspond to respective subsets of one or more bits of the counter 380-b. The interface block 245-c may use the portions 425 to determine whether a value of a counter 380-b satisfies the one or more threshold values or to identify an error associated with the counter 380-b. For example, a counter 380-b may include a portion 425-a (e.g., a row hammer 1 (RH1) counter) to track a quantity of activations of (e.g., access operations on) a corresponding row 405-a, which may indicate whether the value of the counter 380-b satisfies a first threshold value. If the value of the counter 380-b satisfies the first threshold, the interface block 245-c may reset the portion 425-a.

The counter 380-b may also include a portion 425-b (e.g., a row hammer 2 (RH2) counter) that may track a quantity of occurrences that the counter 380-b (e.g., the portion 425-a) satisfies the first threshold value. For example, the interface block 245-c may increment the portion 425-b based on the value of the counter 380-b satisfying the first threshold value, such as incrementing the portion 425-b each time the portion 425-a satisfies the first threshold value (e.g., each time the portion 425-a is reset). The portion 425-b may indicate whether the value of the counter 380-b satisfies a second threshold value. If the counter 380-b satisfies the second threshold value, the interface block 245-c may reset the portion 425-b (e.g., and the portion 425-a). The counter 380-b may also include a portion 425-c (e.g., one or more parity bits, a cyclic redundancy check (CRC) portion, error correction code (ECC) portion) that the interface block 245-c may use to identify an error associated with the counter 380-b. In some examples, if the portion 425-c indicates a counter error, the interface block 245-c may reset both the portions 425-a and the portion 425-b. Reading the value of the counter 380-b may include reading the portions 425-a, 425-b, and 425-c. The interface block 245-c may compare the portions 425-a and 425-b to the first and second threshold value, respectively, and use the portion 425-c to determine whether there is an error associated with the counter 380-b.

The interface block 245-c may generate the alert signaling 415 according to various alert types based on comparing a value of the counter 380-b to the one or more threshold values or identifying an error with the counter 380-b. A first alert type (e.g., RH1 alert, RHALERT1) may be associated with the value of the counter 380-b (e.g., in the portion 425-a) satisfying the first threshold value. A second alert type (e.g., RH2 alert, RHALERT2) may be associated with the value of the counter 380-b (e.g., in the portion 425-b) satisfying the second threshold value. In some examples, the second threshold value may be greater than the first threshold value (e.g., may be a multiple of the first threshold value), for example, based on the RH2 counter being incremented in response to the first threshold value being satisfied. A third alert type (e.g., a counter error alert, RHALERTERR) may be associated with the interface block 245-c identifying an error (e.g., a permanent error, a transient error) with the counter 380-b (e.g., indicated by the portion 425-c). A fourth alert type may be associated with the value of the counter 380-b failing to satisfy the one or more threshold values (e.g., the first threshold value and the second threshold value) and that no error is identified for the counter 380-b. The interface block 245-c may transmit different alert values (e.g., via alert pins, such as of a bus 301) via the alert signaling 415 according to the different alert types as described herein. In some examples, if the value of the counter 380-b fails to satisfy the one or more thresholds, the interface block 245-c may refrain from generating alert signaling 415 according to the fourth alert type (e.g., no alert). For example, the fourth alert type may correspond to no alert being sent.

In some examples, the interface block 245-c and the interface block 220-c may support the implementation of other alert types in addition to the four alert types described (e.g., RH1 alert, RH2 alert, a counter error alert, a fourth alert). For example, one or more additional alert types (e.g., a row hammer 3 (RH3) alert, a row hammer 4 (RH4) alert, and so on) may be associated with respective values of the counter satisfying one or more additional respective threshold values (e.g., a third threshold value, a fourth threshold value, and so on). In some examples, the counter 380-b may include one or more additional portions 425 to track respective quantities of row activations, respective quantities of occurrences that a value of the counter satisfies one or more threshold values, or both. For instance, an additional portion 425 may track a quantity of occurrences that the counter 380-b (e.g., the portion 425-b) satisfies the second threshold value.

The interface block 220-c may receive the alert signaling 415 and may evaluate the alert signaling 415. For example, the alert signaling 415 may include different values for different alert types (e.g., RH1ALERT, RH2ALERT, RHALERTERR), and the interface block 220-c may generate and transmit refresh signaling 420 (e.g., for one or more refresh operations) to the interface block 245-c based on the alert type. For instance, if the alert signaling 415 indicates a two-bit value for an alert, a ‘00’ value may correspond to (e.g., indicate) the fourth alert type (e.g., no alert, continue operation), a ‘01’ value may correspond to the first alert type, a ‘10’ may correspond to the second alert type, and a ‘11’ value may correspond to the third alert type (e.g., an error), although other quantities of bits and other combinations of bit values to indicate the alert types may be implemented.

The interface block 220-c may determine which row 405-a is associated with the alert signaling 415 (e.g., an aggressor row) based on a duration (e.g., a quantity of clock cycles) between transmitting the access signaling 410 and receiving the alert signaling 415 (e.g., the timing for the alert signaling 415 may be deterministic). For example, a row hammer alert may be asserted (e.g., the alert signaling 415 may be transmitted to the interface block 220-c) in accordance with a deterministic duration (e.g., quantity of clock cycles, such as 13 command clock cycles) after the access signaling 410 (e.g., an activate command) is transmitted to the interface block 245-c. Accordingly, the interface block 220-c may determine the row 405-a for which the alert signaling 415 is indicating an alert based on having issued the access signaling 410 for the row 405-a (e.g., a quantity of clock cycles prior to receiving the alert signaling 415).

The refresh signaling 420 may include one or more refresh commands (e.g., a target auto refresh (TAREF) command) for one or more rows 405-a based on the alert type. Each refresh command may indicate one or more parameters (e.g., PC, bank address, victim row address) associated with the one or more rows 405-a to be refreshed. In some examples, if the alert type is a first alert type (e.g., RH1ALERT), the refresh signaling 420 may include multiple refresh commands (e.g., at least two refresh commands) to refresh multiple rows 405-a that are near (e.g., directly adjacent to, neighboring) the row 405-a (e.g., the aggressor row) associated with the alert signaling 415 (e.g., the row 405-a that is under row hammer attack). For example, if the alert signaling 415 indicates the first alert type associated with row 405-a-4, the interface block 220-c may issue respective refresh commands for row 405-a-3 and row 405-a-5 that are directly adjacent to the row 405-a-4. In some examples, a single refresh command may indicate multiple rows 405 to be refreshed, and the interface block 220-c may issue a single refresh command for the rows 405-a-3 and 405-a-5.

If the alert type indicates a second alert type (e.g., RH2ALERT) or a third alert type (e.g., RHALERTERR), the refresh signaling 420 may include multiple sets of refresh commands (e.g., at least four respective refresh commands for four rows 405-a). For example, in response to the second alert type being associated with the row 405-a-4, the interface block 220-c may issue respective refresh commands for row 405-a-2, row 405-a-3, row 405-a-5, and row 405-a-6. In some examples, a single refresh command may indicate multiple rows 405 to be refreshed, and the interface block 220-c may issue one or more refresh commands to indicate a refresh of the rows 405-a-2, 405-a-3, 405-a-5, and 405-a-6. In some examples, the second alert type may cause additional rows 405-a to be refreshed relative to the first alert type due to the higher quantity of activations (e.g., of the row 405-a-4) associated with indicating the second alert type relative to the first alert type. For example, the higher quantity of activations may be associated with additional electrical charge leakage from an aggressor row 405-a, which may modify data in additional rows 405-a, for example, located further away from the aggressor row 405-a than adjacent victim rows 405-a associated with the first alert type. For example, the second alert type may indicate that rows 405-a that are not directly adjacent to the aggressor row 405-a may be affected by a row hammer attack on the aggressor row 405-a. As such, the rows 405-a that are not directly adjacent to an aggressor row 405-a may be indicated by the alert signaling 415 to be refreshed. In some examples, if the alert type indicates an additional alert type (e.g., an RH3 alert, an RH4 alert, and so on), the refresh signaling 420 may indicate refreshes for other rows 405-a in addition to the rows 405-a indicated for refresh in association with the second alert type (e.g., rows 405-a-1, 405-a-7, and so on), for example, due to an even higher quantity of activations of the aggressors row 405-a associated with the additional alert type.

In some examples, it may be unclear whether the first threshold value is satisfied, the second threshold value is satisfied, or neither the first nor the second threshold values are satisfied if the third alert type is indicated, for example, due to an error in reading the value of a counter 380-b. As such, the interface block 245-c may assume that the second threshold value is satisfied (e.g., as a conservative assumption) and issue refresh commands to refresh both the directly adjacent and non-directly adjacent rows 405-a, for example, to support robust row hammer mitigation in case of an error. If the alert type is a fourth alert type (e.g., indicating no alert and no counter error), the interface block 220-c may not generate the refresh signaling 420.

Supporting various alert types for row hammer mitigation operations as described herein may increase a robustness of row hammer mitigation techniques, increase system security and data protection against row hammer attacks, and increase a performance of row hammer mitigation operations. For example, supporting the second alert type and issuance of refresh commands for non-directly adjacent rows 405-a may protect against relatively longer and sustained row hammer attacks on an aggressor row 405-a that may affect the non-directly adjacent rows 405-a in addition to directly adjacent rows 405-a. Additionally, or alternatively, supporting the first alert type and issuance of refresh commands for directly adjacent rows 405-a may reduce a quantity of rows 405-a that are refreshed relative to the second alert type, which may reduce a latency or power consumption associated with row hammer mitigation. Further, supporting the third type of alert may provide protection against row hammer attacks in case of counter error.

The interface block 220-c may receive multiple alerts for multiple rows 405-a. In some examples, the multiple rows 405-a associated with the multiple alerts may have addresses that are nearby (e.g., adjacent) to each other. In such examples, the interface block 220-c may reduce a quantity of refresh commands for the refresh signaling 420. For example, the interface block 220-c may receive a first alert having the first alert type for row 405-a-4 and a second alert having the first alert type for row 405-a-5, which may result in refresh commands for row 405-a-3 and row 405-a-5 (associated with row 405-a-4) and for row 405-a-4 and row 405-a-6 (associated with row 405-a-5). However, the interface block 220-c may exclude refresh commands for the row 405-a-4 and the row 405-a-5 from the refresh signaling 420 based on the row 405-a-4 being adjacent to the row 405-a-5.

In some examples, the refresh signaling 420 may additionally, or alternatively, include a refresh command that is not targeted to a specific row 405-a (e.g., an auto refresh (AREF) command), but may indicate the interface block 245-c to refresh multiple rows 405-a (e.g., of a bank). For example, the interface block 220-c may issue such refresh commands periodically to maintain the state of multiple rows (e.g., as part of a system maintenance procedure). Such refresh commands may indicate one or more parameters (e.g., PC, bank address) for multiple rows 405-a.

In some examples, the refresh signaling 420 may be based on whether the row 405-a is associated with the alert signaling 415 is a spare row (e.g., a repaired row). For example, the access signaling 410 may indicate to access a row 405-a that is a spare row (e.g., a redundant row, a replacement row), which may be located physically apart from other rows 405-a of the memory array 250-c (e.g., in a different memory array 250, in a different portion of the memory array 250), but which may be located logically adjacent to one or more of the other rows 405-a.

In response to receiving the refresh signaling 420, the interface block 245-c may perform one or more refresh operations based on indications included in the refresh signaling 420. In some examples, the interface block 245-c may also increment respective counters 380-b associated with rows 405-a refreshed in accordance with the one or more refresh commands. For instance, if the refresh signaling 420 includes a targeted refresh command (e.g., TAREF command) for row 405-a-3, the interface block 245-c may also increment the associated counter 380-b-3, as performing the refresh of the row 405-a-3 may include activating the row 405-a-3. In some cases, if the refresh command is an auto refresh command (e.g., AREF command), the interface block 245-c may reset the counters 380-b (e.g., both RH1 counters and RH2 counters) corresponding to the rows 405-a associated with the auto refresh command (e.g., and may not increment the counters 380-b).

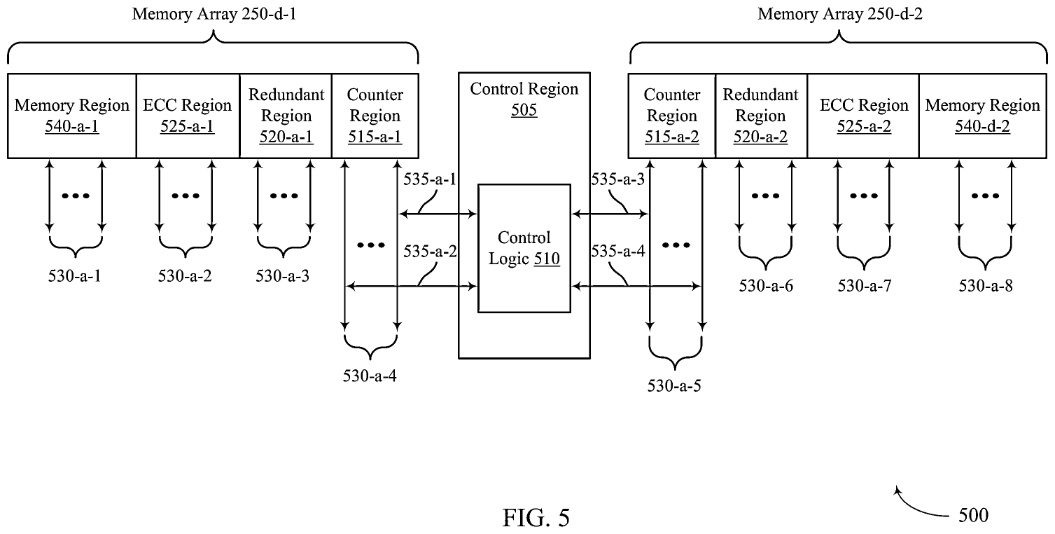

FIG. 5 shows an example of an architecture 500 that supports row hammer mitigation for stacked memory architectures in accordance with examples as disclosed herein. The architecture 500 may illustrate a portion of a die 240. For example, the architecture 500 illustrates an example of a control region 505 (e.g., of an interface block 245) that includes control logic 510. In some examples, the control logic 510 may include or be an example of a control interface 310, an interface controller 320, or a combination thereof. In some examples, the control region 505 may be a region of a die 240 (e.g., an interface block 245) that includes bank logic. The control region 505 may be associated with one or more memory arrays 250-d (e.g., according to a channel pair arrangement). For example, the control logic 510 may control accessing of various regions of a memory array 250-d, such as one or more counter regions 515-a, one or more redundant regions 520-a, one or more ECC regions 525-a, and one or more memory regions 540-a, with each region being associated with respective access lines 530-a (e.g., GIOs).

A counter region 515-a may be a portion of a memory array 250-d used to maintain counters 380. For example, memory cells of the counter region 515-a may be accessed to read and write values of counters 380 to support row hammer mitigation operations as described herein. A redundant region 520-a may be a portion of a memory array 250-d that includes redundant memory cells, such as spare rows. An ECC region 525-a may be a portion of a memory array 250-d in which information associated with ECC operations (e.g., parity bits) may be stored. A memory region 540-a may be a portion of a memory array 250-d used to store data to memory cells of the memory region 540-a.

In some implementations, memory arrays 250-d may include one or more counters 380 (e.g., to support row hammer mitigations operations). In some cases, to access the one or more counters 380, a device may use access lines 530-a that are shared with data signaling associated with the memory array 250-d (e.g., access lines 530-a-1), or other access lines 530-a associated with other regions. However, using shared access lines (e.g., access lines 530-a) may increase latency and signaling overhead in a memory system.

According to techniques described herein, the control logic 510 may be operable to couple (e.g., directly couple) with counter regions 515-a via conductive lines 535-a coupled with dedicated access lines 530-a. For example, a memory array 250-d may include dedicated access lines 530-a (e.g., dedicated GIO lines, dedicated column lines, dedicated buses) coupled with memory cells of a counter region 515-a, which the control logic 510 may access via conductive lines 535-a. For instance, the control logic 510 may use the conductive lines 535-a and access lines 530-a (e.g., access lines 530-a-4 coupled with a counter region 515-a-1, access lines 530-a-5 coupled with a counter region 515-a-2) to directly access the counters 380 (e.g., rather than accessing the counters 380 via access lines 530-a of other regions).

In some examples, an interface block 245 may use the control logic 510 to read a counter 380 via the conductive lines 535-a and access lines 530-a based on receiving access signaling for a row of a memory array 250-d. In some examples, a counter region 515-a may include a column decoder (e.g., a dedicated column decoder) via which the control logic 510 may access a counter 380 of the counter region 515-a using the dedicated access lines 530-a. The control logic 510 may increment the value of the counter 380 based on the interface block 245 accessing a row of the memory array 250-d associated with the counter 380 (e.g., using a word line that spans a memory region 540, an ECC region 525, a redundant region 520, and a counter region 515). The control logic 510 may compare a value of the counter 380 (e.g., after incrementing) to one or more threshold values (e.g., as described with reference to FIG. 4), and the interface block 245 may transmit alert signaling (e.g., to an interface block 220) based on the comparing. The control logic 510 may write the incremented value back to the counter 380 via the conductive lines 535-a and access lines 530-a. Thus, the dedicated conductive lines 535-a and access lines 530-a may increase reliability and decrease latency associated with row hammer mitigation procedures.

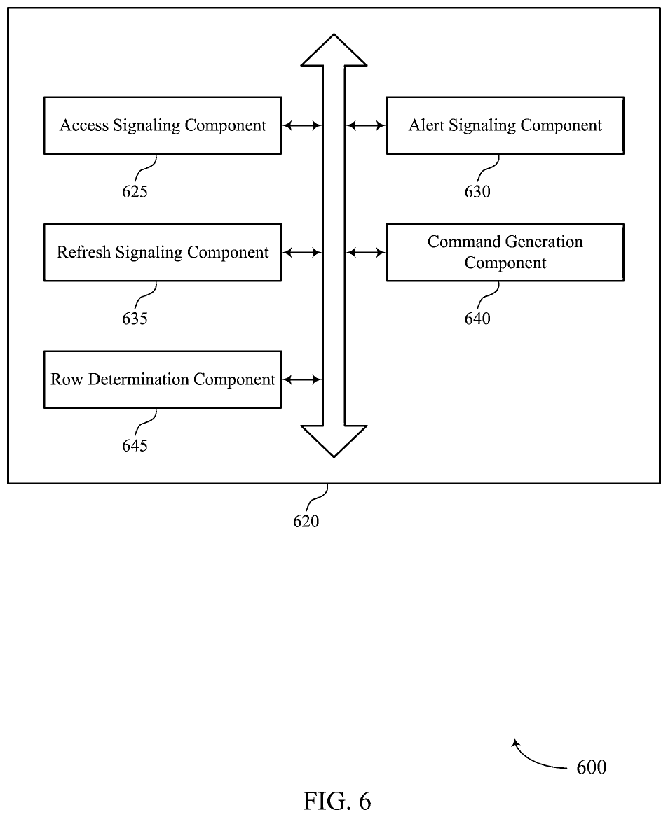

FIG. 6 shows a block diagram 600 of a logic die 620 (e.g., a die 205) that supports row hammer mitigation for stacked memory architectures in accordance with examples as disclosed herein. The logic die 620 may be an example of aspects of a logic die as described with reference to FIGS. 1 through 5. The logic die 620, or various components thereof (e.g., an interface block 220), may be an example of means for performing various aspects of row hammer mitigation for stacked memory architectures as described herein. For example, the logic die 620 (e.g., an interface block 220) may include an access signaling component 625, an alert signaling component 630, a refresh signaling component 635, a command generation component 640, a row determination component 645, or any combination thereof. Each of these components, or components of subcomponents thereof (e.g., one or more processors, one or more memories), may communicate, directly or indirectly, with one another (e.g., via one or more buses).

The access signaling component 625 may be configured as or otherwise support a means for transmitting, from a first interface (e.g., an interface block 220) of a first semiconductor die (e.g., the logic die 620) to a second interface (e.g., an interface block 245) of a second semiconductor die (e.g., an array die, a die 240) coupled with the first semiconductor die, first signaling (e.g., one or more first signals, a first signal) including a first command to activate a row of a memory array of the second semiconductor die. The alert signaling component 630 may be configured as or otherwise support a means for receiving, at the first interface from the second interface based on transmitting the first signaling, second signaling (e.g., one or more second signals, a second signal) including an alert message associated with a row hammer mitigation operation associated with the row of the memory array. The refresh signaling component 635 may be configured as or otherwise support a means for transmitting, from the first interface to the second interface based on the alert message, third signaling (e.g., one or more third signals, a third signal) including a second command to refresh one or more rows of the memory array adjacent to the row of the memory array.

In some examples, the command generation component 640 may be configured as or otherwise support a means for generating, by the first interface, the third signaling including the second command, the second command indicating to refresh a first row of the memory array and a second row of the memory array that are adjacent to the row based on the alert message indicating that a quantity of activations of the row satisfies a first threshold.

In some examples, the command generation component 640 may be configured as or otherwise support a means for generating, by the first interface, the third signaling including the second command, the second command indicating to refresh a first set of rows of the memory array and a second set of rows that are adjacent to the row based on the alert message indicating that a quantity of activations of the row satisfies a second threshold greater than a first threshold or indicating an error associated with a counter for counting activations of the row.

In some examples, the row determination component 645 may be configured as or otherwise support a means for determining, by the first interface, that the second signaling is associated with the row based on a duration between transmitting the first signaling and receiving the second signaling.

In some examples, the alert signaling component 630 may be configured as or otherwise support a means for receiving, at the first interface from the second interface, a second alert message associated with a second row hammer mitigation operation associated with a second row adjacent to the row. In some examples, the third signaling is transmitted based on receiving the alert message and the second alert message.

In some examples, the second command to refresh the one or more rows is based on whether the row is a spare row of the memory array.

In some examples, the described functionality of the logic die 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the logic die 620, or various components thereof, may be implemented at least in part by instructions (e.g., stored in memory, non-transitory computer-readable medium) executable by such at least one processor.

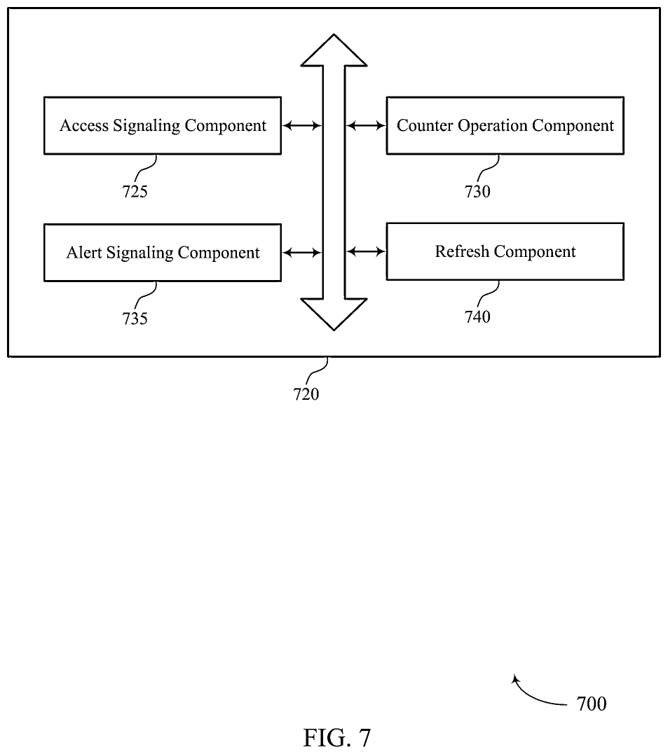

FIG. 7 shows a block diagram 700 of an array die 720 (e.g., a die 240) that supports row hammer mitigation for stacked memory architectures in accordance with examples as disclosed herein. The array die 720 may be an example of aspects of an array die as described with reference to FIGS. 1 through 5. The array die 720, or various components thereof (e.g., an interface block 245), may be an example of means for performing various aspects of row hammer mitigation for stacked memory architectures as described herein. For example, the array die 720 (e.g., an interface block 245) may include an access signaling component 725, a counter operation component 730, an alert signaling component 735, a refresh component 740, or any combination thereof. Each of these components, or components of subcomponents thereof (e.g., one or more processors, one or more memories), may communicate, directly or indirectly, with one another (e.g., via one or more buses).

The access signaling component 725 may be configured as or otherwise support a means for receiving, at a second interface (e.g., an interface block 245) of a second semiconductor die (e.g., the array die 720) from a first interface (e.g., an interface block 220) of a first semiconductor die (e.g., a logic die, a die 205) operable to couple with the second semiconductor die, first signaling (e.g., one or more first signals, a first signal) including a first command to activate a row of a memory array of the second semiconductor die. The counter operation component 730 may be configured as or otherwise support a means for incrementing, by the second interface, a value of a counter associated with the row based on activating the row in accordance with the first signaling. In some examples, the counter operation component 730 may be configured as or otherwise support a means for reading, by the second interface, the value of the counter after incrementing the value of the counter. The alert signaling component 735 may be configured as or otherwise support a means for transmitting, from the second interface to the first interface based on reading the value of the counter, second signaling (e.g., one or more second signals, a second signal) including an alert message associated with a row hammer mitigation operation associated with the row.

In some examples, the refresh component 740 may be configured as or otherwise support a means for receiving, at the second interface from the first interface based on the alert message, third signaling (e.g., one or more third signals, a third signal) including a second command to refresh one or more rows of the memory array adjacent to the row of the memory array. In some examples, the refresh component 740 may be configured as or otherwise support a means for refreshing the one or more rows based on the second command.

In some examples, the alert message indicates that the value of the counter satisfies a first threshold value. In some examples, the counter operation component 730 may be configured as or otherwise support a means for resetting a first portion of the counter based on the value of the counter satisfying the first threshold value and incrementing a second portion of the counter based on resetting the first portion of the counter.

In some examples, the alert message indicates that the value of the counter satisfies a second threshold value greater than a first threshold value. In some examples, the counter operation component 730 may be configured as or otherwise support a means for resetting the counter based on the value of the counter satisfying the second threshold value.

In some examples, the alert message indicates an error associated with the counter. In some examples, the counter operation component 730 may be configured as or otherwise support a means for resetting the counter based on identifying the error.

In some examples, the described functionality of the array die 720, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the array die 720, or various components thereof, may be implemented at least in part by instructions (e.g., stored in memory, non-transitory computer-readable medium) executable by such at least one processor.

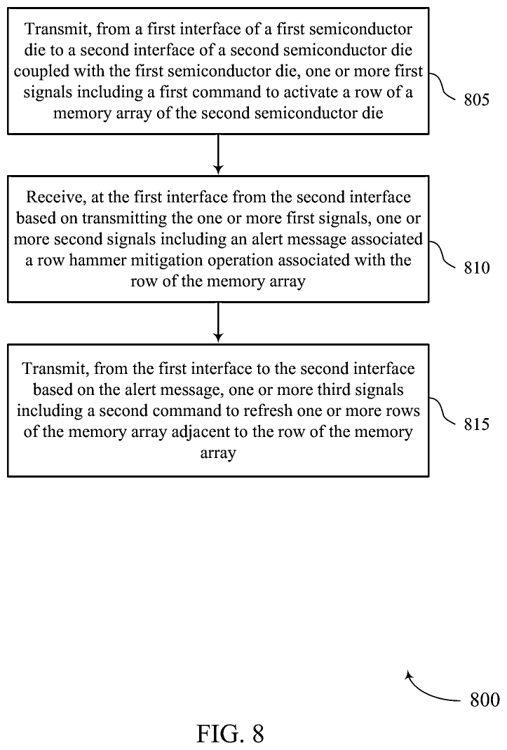

FIG. 8 shows a flowchart illustrating a method 800 that supports row hammer mitigation for stacked memory architectures in accordance with examples as disclosed herein. The operations of method 800 may be implemented by a logic die (e.g., a die 205) or its components as described herein (e.g., an interface block 220). For example, the operations of method 800 may be performed by a logic die as described with reference to FIGS. 1 through 6. In some examples, a logic die may execute a set of instructions to control the functional elements of the device to perform the described functions. Additionally, or alternatively, the logic die may perform aspects of the described functions using special-purpose hardware.

At 805, the method may include transmitting, from a first interface of a first semiconductor die (e.g., the logic die) to a second interface of a second semiconductor die coupled with the first semiconductor die, one or more first signals including a first command to activate a row of a memory array of the second semiconductor die. For example, a die 205 may include an interface block 220 that transmits access signaling 410 (e.g., via buses 221, buses 301) to an interface block 245 of a die 240 to activate a row 405 of a memory array 250. In some examples, aspects of the operations of 805 may be performed by an access signaling component 625 as described with reference to FIG. 6.

At 810, the method may include receiving, at the first interface from the second interface based on transmitting the one or more first signals, one or more second signals including an alert message associated with a row hammer mitigation operation associated with the row of the memory array. For example, an interface block 220 of a die 205 may receive alert signaling 415 from an interface block 245 (e.g., via buses 221, buses 301) of a die 240 for a row hammer mitigation operation associated with a row 405 of a memory array 250. In some examples, aspects of the operations of 810 may be performed by an alert signaling component 630 as described with reference to FIG. 6.

At 815, the method may include transmitting, from the first interface to the second interface via based on the alert message, one or more third signals including a second command to refresh one or more rows of the memory array adjacent to the row of the memory array. For example, an interface block 220 of a die 205 may transmit refresh signaling 420 (e.g., via buses 221, buses 301) to an interface block 245 of a die 240 indicating a refresh operation for one or more rows 405 of a memory array 250. In some examples, aspects of the operations of 815 may be performed by a refresh signaling component 635 as described with reference to FIG. 6.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for transmitting, from a first interface of a first semiconductor die to a second interface of a second semiconductor die coupled with the first semiconductor die, one or more first signals including a first command to activate a row of a memory array of the second semiconductor die; receiving, at the first interface from the second interface based on transmitting the one or more first signals, one or more second signals including an alert message associated with a row hammer mitigation operation associated with the row of the memory array; and transmitting, from the first interface to the second interface based on the alert message, one or more third signals including a second command to refresh one or more rows of the memory array adjacent to the row of the memory array.

Aspect 2: The method, apparatus, or non-transitory computer-readable medium of aspect 1, further including operations, features, circuitry, logic, means, or instructions, or any combination thereof for generating, by the first interface, the one or more third signals including the second command, the second command indicating to refresh a first row of the memory array and a second row of the memory array that are adjacent to the row based on the alert message indicating that a quantity of activations of the row satisfies a first threshold.

Aspect 3: The method, apparatus, or non-transitory computer-readable medium of any of aspects 1 through 2, further including operations, features, circuitry, logic, means, or instructions, or any combination thereof for generating, by the first interface, the one or more third signals including the second command, the second command indicating to refresh a first set of rows of the memory array and a second set of rows that are adjacent to the row based on the alert message indicating that a quantity of activations of the row satisfies a second threshold greater than a first threshold or indicating an error associated with a counter for counting activations of the row.

Aspect 4: The method, apparatus, or non-transitory computer-readable medium of any of aspects 1 through 3, further including operations, features, circuitry, logic, means, or instructions, or any combination thereof for determining, by the first interface, that the one or more second signals are associated with the row based on a duration between transmitting the one or more first signals and receiving the one or more second signals.

Aspect 5: The method, apparatus, or non-transitory computer-readable medium of any of aspects 1 through 4, further including operations, features, circuitry, logic, means, or instructions, or any combination thereof for receiving, at the first interface from the second interface, a second alert message associated with a second row hammer mitigation operation associated with a second row adjacent to the row and where the one or more third signals are transmitted based on receiving the alert message and the second alert message.

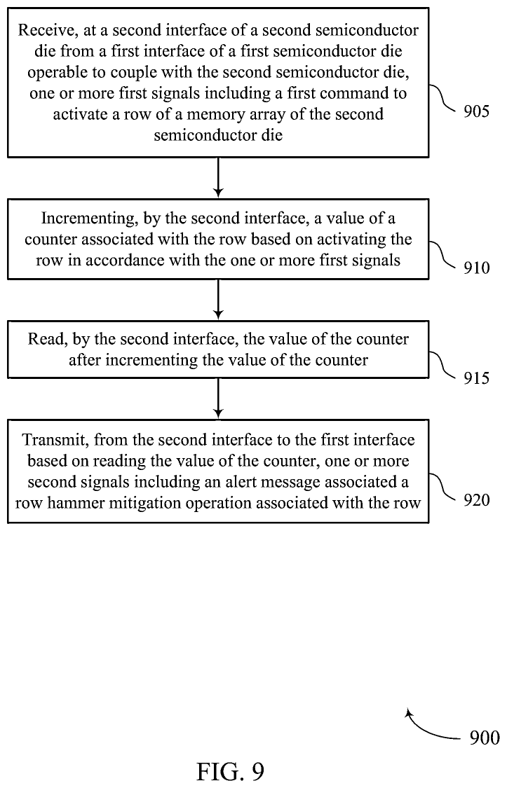

FIG. 9 shows a flowchart illustrating a method 900 that supports row hammer mitigation for stacked memory architectures in accordance with examples as disclosed herein. The operations of method 900 may be implemented by an array die (e.g., a die 240) or its components (e.g., an interface block 245) as described herein. For example, the operations of method 900 may be performed by an array die as described with reference to FIGS. 1 through 5 and 7. In some examples, an array die may execute a set of instructions to control the functional elements of the device to perform the described functions. Additionally, or alternatively, the array die may perform aspects of the described functions using special-purpose hardware.

At 905, the method may include receiving, at a second interface of a second semiconductor die (e.g., the array die) from a first interface of a first semiconductor die operable to couple with the second semiconductor die, one or more first signals including a first command to activate a row of a memory array of the second semiconductor die. For example, an interface block 245 of a die 240 may receive (e.g., via buses 246, buses 301) access signaling 410 from an interface block 220 of a die 205 to activate a row 405 of a memory array 250. In some examples, aspects of the operations of 905 may be performed by an access signaling component 725 as described with reference to FIG. 7.

At 910, the method may include incrementing, by the second interface, a value of a counter associated with the row based on activating the row in accordance with the one or more first signals. For example, an interface block 245 of a die 240 may increment a value of a counter 380 based on activating a row 405 in accordance with access signaling 410. In some examples, aspects of the operations of 910 may be performed by a counter operation component 730 as described with reference to FIG. 7.

At 915, the method may include reading, by the second interface, the value of the counter after incrementing the value of the counter. For example, an interface block 245 of a die 240 may read the value of a counter 380 after incrementing the counter 380. In some examples, aspects of the operations of 915 may be performed by a counter operation component 730 as described with reference to FIG. 7.

At 920, the method may include transmitting, from the second interface to the first interface based on reading the value of the counter, one or more second signals including an alert message associated with a row hammer mitigation operation associated with the row. For example, an interface block 245 of a die 240 may transmit (e.g., via buses 246, buses 301) alert signaling 415 indicating an alert message associated with a row hammer mitigation operation to an interface block 220 of a die 205 based on reading a value of a counter 380. In some examples, aspects of the operations of 920 may be performed by an alert signaling component 735 as described with reference to FIG. 7.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:

Aspect 6: A method, apparatus, or non-transitory computer-readable medium including operations, features, circuitry, logic, means, or instructions, or any combination thereof for receiving, at a second interface of a second semiconductor die from a first interface of a first semiconductor die operable to couple with the second semiconductor die, one or more first signals including a first command to activate a row of a memory array of the second semiconductor die; incrementing, by the second interface, a value of a counter associated with the row based on activating the row in accordance with the one or more first signals; reading, by the second interface, the value of the counter after incrementing the value of the counter; and transmitting, from the second interface to the first interface based on reading the value of the counter, one or more second signals including an alert message associated with a row hammer mitigation operation associated with the row.

It should be noted that the methods described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 7: An apparatus, including: a first semiconductor die including: a first interface, the first interface including first circuitry operable to transmit one or more access signals; and a second semiconductor die coupled with the first semiconductor die, the second semiconductor die including: one or more memory arrays; and a second interface coupled with the first interface and the one or more memory arrays, the second interface including second circuitry operable to access the one or more memory arrays based on receiving the one or more access signals, where the apparatus is operable to: transmit, from the second interface to the first interface, one or more first signals based on a value of a counter associated with a quantity of access operations on the one or more memory arrays; transmit, from the first interface to the second interface based on the first interface receiving the one or more first signals, one or more second signals indicating a refresh operation associated with one or more addresses of the one or more memory arrays; and perform, by the second interface, the refresh operation based on the second interface receiving the one or more second signals.

Aspect 8: The apparatus of aspect 7, where the second circuitry of the second interface is further operable to: compare the value of the counter to one or more threshold values; and transmit the one or more first signals to the first interface based on the comparing.

Aspect 9: The apparatus of aspect 8, where the second circuitry of the second interface is further operable to: read the value of the counter based on receiving the one or more access signals from the first interface; increment the value of the counter based on accessing the one or more memory arrays, where the value of the counter is compared to the one or more threshold values after the incrementing; and write the incremented value to the counter.

Aspect 10: The apparatus of any of aspects 7 through 9, where the second circuitry of the second interface is further operable to: perform one or more access operations on an address of the one or more memory arrays; and perform, concurrently with performing the one or more access operations, one or more operations to track, using the counter, a quantity of access operations on the address.

Aspect 11: The apparatus of any of aspects 7 through 10, where the one or more first signals are transmitted based on the value of the counter indicating that a quantity of access operations on an address of the one or more memory arrays satisfies one or more threshold values.

Aspect 12: The apparatus of aspect 11, where the one or more first signals indicate that the value of the counter satisfies a first threshold value of the one or more threshold values, the apparatus further operable to: reset, by the second interface, a first portion of the counter based on the value of the counter satisfying the first threshold value; increment, by the second interface, a second portion of the counter based on the value of the counter satisfying the first threshold value; and generate, by the first interface, the one or more second signals indicating the refresh operation, where the refresh operation is for a second address different from the address and a third address different from the address based on the one or more first signals indicating that the value of the counter satisfies the first threshold value.

Aspect 13: The apparatus of aspect 11, where the one or more first signals indicate that the value of the counter satisfies a second threshold value of the one or more threshold values greater than a first threshold value of the one or more threshold values, the apparatus further operable to: reset, by the second interface, the counter based on the value of the counter satisfying the second threshold value; and generate, by the first interface, the one or more second signals indicating the refresh operation for a first set of addresses that are different from the address and a second set of addresses that different from the address based on the one or more first signals indicating that the value of the counter satisfies the second threshold value.

Aspect 14: The apparatus of aspect 11, where the one or more first signals indicate an error associated with the counter, the apparatus further operable to: reset, by the second interface, the counter based on the error; and generate, by the first interface, the one or more second signals indicating the refresh operation for a first set of addresses that are different from the address and a second set of addresses that are different from the address based on the one or more first signals indicating the error.

Aspect 15: The apparatus of any of aspects 7 through 14, where the first circuitry of the first interface is further operable to determine an address of the one or more memory arrays associated with the one or more first signals based on a duration between transmitting the one or more access signals from the first interface and receiving the one or more first signals from the second interface.

Aspect 16: The apparatus of any of aspects 7 through 15, where the one or more first signals are associated with a first address of the one or more memory arrays and a second address of the one or more memory arrays adjacent to the first address, and where the first circuitry of the first interface is operable to: determine the one or more addresses for the refresh operation to be adjacent to the first address or the second address and to exclude the first address and the second address based on the first address and the second address being adjacent.

Aspect 17: The apparatus of any of aspects 7 through 16, where the apparatus is further operable to: transmit, from the first interface to the second interface, one or more third signals indicating a second refresh operation associated with a set of addresses of the one or more memory arrays; and reset, by the second interface, respective counters associated with each address of the set of addresses based on the one or more third signals.

Aspect 18: The apparatus of any of aspects 7 through 17, where the second signaling indicating the refresh operation is based on the one or more addresses being associated with a spare row of the one or more memory arrays.

Aspect 19: The apparatus of any of aspects 7 through 18, where the second semiconductor die includes: the counter; and one or more dedicated access lines coupled with the second interface for accessing the counter.

An apparatus is described. The following provides an overview of aspects of the apparatus as described herein:

Aspect 20: An apparatus, including: a first semiconductor die including a first interface, the first interface including circuitry operable to: transmit, to a second interface of a second semiconductor die coupled with the first semiconductor die, one or more first signals including a first command to activate a row of a memory array of the second semiconductor die; receive, from the second interface based on transmitting the one or more first signals, one or more second signals including an alert message associated with a row hammer mitigation operation associated with the row of the memory array; and transmit, to the second interface based on the alert message, one or more third signals including a second command to refresh one or more rows of the memory array adjacent to the row of the memory array.

Aspect 21: The apparatus of aspect 20, where the circuitry of the first interface is operable to: generate the third signaling including the second command, the second command indicating to refresh a first row of the memory array and a second row of the memory array that are different from the row based on the alert message indicating that a quantity of activations of the row satisfies a first threshold.

Aspect 22: The apparatus of aspect 20, where circuitry of the first interface is operable to: generate the third signaling including the second command, the second command indicating to refresh a first set of rows of the memory array and a second set of rows that are different from the row based on the alert message indicating that a quantity of activations of the row satisfies a second threshold greater than a first threshold or indicating an error associated with a counter for counting activations of the row.

Aspect 23: The apparatus of any of aspects 20 through 22, where the circuitry of the first interface is operable to: determine that the second signaling is associated with the row based on a duration between transmitting the first signaling and receiving the second signaling.

Aspect 24: The apparatus of any of aspects 20 through 23, where the circuitry operable to transmit the third signaling is further operable to: transmit the third signaling based on receiving the alert message and receiving a second alert message associated with a second row hammer mitigation operation associated with a second row adjacent to the row.

Aspect 25: The apparatus of any of aspects 20 through 24, where the second command to refresh the one or more rows is based on whether the row is a spare row of the memory array.

An apparatus is described. The following provides an overview of aspects of the apparatus as described herein:

Aspect 26: An apparatus, including: a second semiconductor die including a second interface, the second interface including circuitry operable to: receive, from a first interface of a first semiconductor die, first signaling including a command to activate a row of a memory array of the second semiconductor die; increment a value of a counter associated with the row based on activating the row in accordance with the first signaling; read the value of the counter after incrementing the value of the counter; and transmit, to the first interface based on reading the value of the counter, second signaling including an alert message associated with a row hammer mitigation operation associated with the row.

Aspect 27: The apparatus of aspect 26, where the circuitry of the second interface further operable to: receive, from the first interface based on the alert message, third signaling including a second command to refresh one or more rows of the memory array adjacent to the row of the memory array; and refresh the one or more rows based on the second command.

Aspect 28: The apparatus of any of aspects 26 through 27, where the alert message indicates that the value of the counter satisfies a first threshold value, the circuitry of the second interface further operable to: reset a first portion of the counter based on the value of the counter satisfying the first threshold value; and increment a second portion of the counter based on resetting the first portion of the counter.

Aspect 29: The apparatus of any of aspects 26 through 27, where the alert message indicates that the value of the counter satisfies a second threshold value greater than a first threshold value, the circuitry of the second interface further operable to: reset the counter based on the value of the counter satisfying the second threshold value.

Aspect 30: The apparatus of any of aspects 26 through 27, where the alert message indicates an error associated with the counter, the circuitry of the second interface further operable to: reset the counter based on identifying the error.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. At any given time, a conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other when the switch is open. When a controller isolates two components, the controller affects a change that prevents signals from flowing between the components using a conductive path that previously permitted signals to flow.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over as one or more instructions (e.g., code) on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and modules described in connection with the disclosure herein may be implemented or performed with a processor, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or any type of processor. A processor may also be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a computer, or a processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A system, comprising:
a first semiconductor die comprising:
a first interface, the first interface comprising first circuitry operable to transmit one or more access signals; and
a second semiconductor die coupled with the first semiconductor die, the second semiconductor die comprising:
one or more memory arrays; and
a second interface coupled with the first interface and the one or more memory arrays, the second interface comprising second circuitry operable to access the one or more memory arrays based on receiving the one or more access signals,
wherein the system is operable to:
transmit, from the second interface to the first interface, one or more first signals based on a value of a counter associated with a quantity of access operations on the one or more memory arrays;
transmit, from the first interface to the second interface based on the first interface receiving the one or more first signals, one or more second signals indicating a refresh operation associated with one or more addresses of the one or more memory arrays; and
perform, by the second interface, the refresh operation based on the second interface receiving the one or more second signals.

2. The system of claim 1, wherein the second circuitry of the second interface is further operable to:
compare the value of the counter to one or more threshold values; and
transmit the one or more first signals to the first interface based on the comparing.

3. The system of claim 2, wherein the second circuitry of the second interface is further operable to:
read the value of the counter based on receiving the one or more access signals from the first interface;
increment the value of the counter based on accessing the one or more memory arrays, wherein the value of the counter is compared to the one or more threshold values after the incrementing; and
write the incremented value to the counter.

4. The system of claim 1, wherein the second circuitry of the second interface is further operable to:
perform one or more access operations on an address of the one or more memory arrays; and
perform, concurrently with performing the one or more access operations, one or more operations to track, using the counter, a quantity of access operations on the address.

5. The system of claim 1, wherein the one or more first signals are transmitted based on the value of the counter indicating that a quantity of access operations on an address of the one or more memory arrays satisfies one or more threshold values.

6. The system of claim 5, wherein the one or more first signals indicate that the value of the counter satisfies a first threshold value of the one or more threshold values, the system further operable to:
reset, by the second interface, a first portion of the counter based on the value of the counter satisfying the first threshold value;
increment, by the second interface, a second portion of the counter based on the value of the counter satisfying the first threshold value; and
generate, by the first interface, the one or more second signals indicating the refresh operation, wherein the refresh operation is for a second address different from the address and a third address different from the address based on the one or more first signals indicating that the value of the counter satisfies the first threshold value.

7. The system of claim 5, wherein the one or more first signals indicate that the value of the counter satisfies a second threshold value of the one or more threshold values greater than a first threshold value of the one or more threshold values, the system further operable to:
reset, by the second interface, the counter based on the value of the counter satisfying the second threshold value; and
generate, by the first interface, the one or more second signals indicating the refresh operation for a first set of addresses that are different from the address and a second set of addresses that different from the address based on the one or more first signals indicating that the value of the counter satisfies the second threshold value.

8. The system of claim 5, wherein the one or more first signals indicate an error associated with the counter, the system further operable to:
reset, by the second interface, the counter based on the error; and
generate, by the first interface, the one or more second signals indicating the refresh operation for a first set of addresses that are different from the address and a second set of addresses that are different from the address based on the one or more first signals indicating the error.

9. The system of claim 1, wherein the first circuitry of the first interface is further operable to determine an address of the one or more memory arrays associated with the one or more first signals based on a duration between transmitting the one or more access signals from the first interface and receiving the one or more first signals from the second interface.

10. The system of claim 1, wherein the one or more first signals are associated with a first address of the one or more memory arrays and a second address of the one or more memory arrays adjacent to the first address, and wherein the first circuitry of the first interface is operable to:
determine the one or more addresses for the refresh operation to be adjacent to the first address or the second address and to exclude the first address and the second address based on the first address and the second address being adjacent.

11. The system of claim 1, wherein the system is further operable to:
transmit, from the first interface to the second interface, one or more third signals indicating a second refresh operation associated with a set of addresses of the one or more memory arrays; and
reset, by the second interface, respective counters associated with each address of the set of addresses based on the one or more third signals.

12. The system of claim 1, wherein the one or more second signals indicating the refresh operation is based on the one or more addresses being associated with a spare row of the one or more memory arrays.

13. The system of claim 1, wherein the second semiconductor die comprises:
the counter; and
one or more dedicated access lines coupled with the second interface for accessing the counter.

14. An apparatus, comprising:
a first semiconductor die comprising a first interface, the first interface comprising circuitry operable to:
transmit, to a second interface of a second semiconductor die coupled with the first semiconductor die, one or more first signals comprising a first command to activate a row of a memory array of the second semiconductor die;
receive, from the second interface based on transmitting the one or more first signals, one or more second signals comprising an alert message associated with a row hammer mitigation operation associated with the row of the memory array; and
transmit, to the second interface based on the alert message, one or more third signals comprising a second command to refresh one or more rows of the memory array adjacent to the row of the memory array.

15. The apparatus of claim 14, wherein the circuitry of the first interface is operable to:
generate the one or more third signals comprising the second command, the second command indicating to refresh a first row of the memory array and a second row of the memory array that are different from the row based on the alert message indicating that a quantity of activations of the row satisfies a first threshold.

16. The apparatus of claim 14, wherein circuitry of the first interface is operable to:
generate the one or more third signals comprising the second command, the second command indicating to refresh a first set of rows of the memory array and a second set of rows that are different from the row based on the alert message indicating that a quantity of activations of the row satisfies a second threshold greater than a first threshold or indicating an error associated with a counter for counting activations of the row.

17. The apparatus of claim 14, wherein the circuitry of the first interface is operable to:
determine that the one or more second signals are associated with the row based on a duration between transmitting the one or more first signals and receiving the one or more second signals.

18. The apparatus of claim 14, wherein the circuitry operable to transmit the one or more third signals is further operable to:
transmit the one or more third signals based on receiving the alert message and receiving a second alert message associated with a second row hammer mitigation operation associated with a second row adjacent to the row.

19. The apparatus of claim 14, wherein the second command to refresh the one or more rows is based on whether the row is a spare row of the memory array.

20. A method, comprising:
transmitting, from a first interface of a first semiconductor die to a second interface of a second semiconductor die coupled with the first semiconductor die, one or more first signals comprising a first command to activate a row of a memory array of the second semiconductor die;
receiving, at the first interface from the second interface based on transmitting the one or more first signals, one or more second signals comprising an alert message associated a row hammer mitigation operation associated with the row of the memory array; and
transmitting, from the first interface to the second interface based on the alert message, one or more third signals comprising a second command to refresh one or more rows of the memory array adjacent to the row of the memory array.

21. The method of claim 20, further comprising:
generating, by the first interface, the one or more third signals comprising the second command, the second command indicating to refresh a first row of the memory array and a second row of the memory array that are adjacent to the row based on the alert message indicating that a quantity of activations of the row satisfies a first threshold.

22. The method of claim 20, further comprising:
generating, by the first interface, the one or more third signals comprising the second command, the second command indicating to refresh a first set of rows of the memory array and a second set of rows that are adjacent to the row based on the alert message indicating that a quantity of activations of the row satisfies a second threshold greater than a first threshold or indicating an error associated with a counter for counting activations of the row.

23. The method of claim 20, further comprising:
determining, by the first interface, that the one or more second signals is associated with the row based on a duration between transmitting the one or more first signals and receiving the one or more second signals.

24. The method of claim 20, further comprising:
receiving, at the first interface from the second interface, a second alert message associated with a second row hammer mitigation operation associated with a second row adjacent to the row,
wherein the one or more third signals is transmitted based on receiving the alert message and the second alert message.

25. An apparatus, comprising:
a second semiconductor die comprising a second interface, the second interface comprising circuitry operable to:
receive, from a first interface of a first semiconductor die, one or more first signals comprising a command to activate a row of a memory array of the second semiconductor die;
increment a value of a counter associated with the row based on activating the row in accordance with the one or more first signals;
read the value of the counter after incrementing the value of the counter; and
transmit, to the first interface based on reading the value of the counter, one or more second signals comprising an alert message associated a row hammer mitigation operation associated with the row.

26. The apparatus of claim 25, wherein the circuitry of the second interface further operable to:
receive, from the first interface based on the alert message, one or more third signals comprising a second command to refresh one or more rows of the memory array adjacent to the row of the memory array; and
refresh the one or more rows based on the second command.

27. The apparatus of claim 25, wherein the alert message indicates that the value of the counter satisfies a first threshold value, the circuitry of the second interface further operable to:
reset a first portion of the counter based on the value of the counter satisfying the first threshold value; and
increment a second portion of the counter based on resetting the first portion of the counter.

28. The apparatus of claim 25, wherein the alert message indicates that the value of the counter satisfies a second threshold value greater than a first threshold value, the circuitry of the second interface further operable to:
reset the counter based on the value of the counter satisfying the second threshold value.

29. The apparatus of claim 25, wherein the alert message indicates an error associated with the counter, the circuitry of the second interface further operable to:
reset the counter based on identifying the error.

30. A method, comprising:
receiving, at a second interface of a second semiconductor die from a first interface of a first semiconductor die operable to couple with the second semiconductor die, one or more first signals comprising a first command to activate a row of a memory array of the second semiconductor die;
incrementing, by the second interface, a value of a counter associated with the row based on activating the row in accordance with the one or more first signals;
reading, by the second interface, the value of the counter after incrementing the value of the counter; and
transmitting, from the second interface to the first interface based on reading the value of the counter, one or more second signals comprising an alert message associated a row hammer mitigation operation associated with the row.
